(19) United States
(12) Patent Application Publication
(10) Pub. No.: US 2024/0419866 A1
(43) Pub. Date: Dec. 19, 2024

(54) SYSTEMS AND METHODS FOR MODELING IMPEDANCE AND FINITE ELEMENT MODELING OF ELECTROCHEMICAL CELLS

(71) Applicant: 24M Technologies, Inc., Cambridge, MA (US)

(72) Inventor: Khosrow NEMATOLLAHI, Carmel, IN (US)

(21) Appl. No.: 18/742,860

(22) Filed: Jun. 13, 2024

Related U.S. Application Data
(60) Provisional application No. 63/532,149, filed on Aug. 11, 2023.
(60) Provisional application No. 63/521,271, filed on Jun. 15, 2023.

(51) Int. Cl. G06F 30/20

(52) U.S. Cl. CPC G06F 30/20

(57) ABSTRACT

A computation system includes a processor, and a memory storing executable instructions for performing operations comprising receiving a dimension of a nanocell, and communicating a nanocell signal to a simulation system to divide a modeled electrochemical cell into a plurality of nanocells based on the received dimension. A first set of first operating parameters, and a solve signal are communicated to cause the simulation system to determine a second operating parameter of each of the plurality of nanocells. The operations includes interrupting the simulation system after a predetermined number of iterative solving cycles, receiving a set of second operating parameters from the simulation system, receiving a second set of first operating parameters determined based at least on the set of second operating parameters, and communicating the second set of first operating parameters to the simulation system for determining an updated second operating parameter of each of the plurality of nanocells.

### CROSS-REFERENCE TO RELATED APPLICATIONS

The present application claims priority to, and the benefit of U.S. Provisional Application No. 63/521,271, file Jun. 15, 2023, and entitled “Systems and Methods for Modeling Impedance in Electrochemical Cells and Electrochemical Cell Systems,” and U.S. Provisional Application No. 63/532,149, filed Aug. 11, 2023, and entitled “Systems and Methods for Finite Element Modeling of Electrochemical Cells,” the entire disclosures of which are hereby incorporated by reference herein.

### TECHNICAL FIELD

Embodiments described herein are related to systems and methods for modeling and estimating impedance in electrochemical cells, and improving finite element analysis (FEA) of electrochemical cells performed by FEA simulation systems by generating nanocells that are mapped onto electrochemical cells modeled in FEA simulation systems.

### BACKGROUND

An important operating parameter or property of electrochemical cells such as, for example, lithium cells (e.g., lithium ion, lithium air, lithium sulfur, etc.), sodium cells, NiCad cells, or any other electrochemical cell, which can impact the performance of electrochemical cells is the heat generated by such electrochemical cells during cell operation. Operation at high temperatures for prolonged periods of time can be detrimental to electrochemical cell performance. For example, operation at high temperature can age electrochemical cells, which negatively impacts the safety and performance of electrochemical cells. Another concern is thermal runaway. Electrochemical cells and particularly, lithium-ion electrochemical cells, can experience thermal runaway if they become overheated, damaged, or experience a short circuit. Once triggered, the exothermic reactions within the battery release heat, leading to a further increase in temperature. This increased temperature then accelerates the chemical reactions, generating even more heat, creating a self-sustaining cycle, which can result in catastrophic consequences, including fires, explosions, and the release of toxic gases. Therefore, determination of heat generation in electrochemical cells or the ability to predict heat generation in electrochemical cells and/or portions of large electrochemical cells is helpful in monitoring and optimizing performance of electrochemical cells. The impedance of electrochemical cells during operation is an indicator of heat generation. However, it can be difficult to predict electrochemical cell impedance and thereby, heat generation at various operating parameters of electrochemical cells.

Additionally, finite element analysis (FEA) simulation systems are often used to model electrochemical cells and determine heat generated by the electrochemical cells and cell assemblies during operation thereof. In modeling these electrochemical cells and determining the parameters of interest of the electrochemical cells, FEA simulation systems assume the operating parameters of the electrochemical cells to be uniform over the entire surface area or volume of the modeled electrochemical cell. While this is acceptable for small electrochemical cells, large area electrochemical cells and cell assemblies experience substantial variations in their operating parameters across their surface area and/or volume. This reduces the accuracy of such FEA simulation systems for modeling electrochemical cells, particularly large electrochemical cells, and substantially increases the computing power used by simulation systems to determine parameters of interest of the electrochemical cell or cell assemblies including electrochemical cells.

### SUMMARY

Embodiments described herein relate to systems and methods for finite element modeling of electrochemical cells by generating nanocells that divide a modeled electrochemical cell into a plurality of nanocells or map a plurality of nanocells onto a modeled electrochemical cell. In particular, systems and methods described herein are related to generating a nanocell having a predetermined dimension, and dividing a finite element model of an electrochemical cell generated in, or provided to a finite element simulation system, into a plurality of nanocells having the predetermined dimension. First operating parameters corresponding to each of the plurality of nanocells are provided to the simulation system and model operating parameters may also be communicated to the simulation system allowing the simulation system to determine second operating parameters of each of the plurality of nanocells. The simulation system is interrupted after a predetermined number of iterations, iterative cycles, or solving cycles and second operating parameters are used to determine a new set of first operating parameters for each of the plurality of nanocells, allowing faster and more accurate finite element modeling of various parameters of the modeled electrochemical cell. Systems and methods described herein are also related to determining of an impedance function based on test electrochemical cell data that is obtained by performing impedance measurements on various electrochemical cells at various test operating parameters. The impedance function is determined based on the test electrochemical cell data and test operating parameters, and can be used to estimate the impedance values of an electrochemical cell based on cell operating parameters at which the electrochemical cell is operating.

In some embodiments, a computation system includes a processor, and a memory operatively coupled to the processor, the memory storing executable instructions that, when executed by the processor, facilitate performance of operations, the operations comprising: receiving a dimension signal indicative of a dimension of a nanocell; communicating a nanocell signal to a simulation system, the nanocell signal configured to divide a modeled electrochemical cell modeled in the simulation system into a plurality of nanocells based on the received dimension of the nanocell; communicating a first set of first operating parameters to the simulation system, each of the first operating parameter in the first set corresponding to a respective nanocell of the plurality of nanocells; communicating a solve signal to the simulation system, the solve signal configured to cause the simulation system to determine a second operating parameter of each of the plurality of nanocells based at least on a corresponding first operating parameter; communicating an interrupt signal to the simulation system, the interrupt signal configured to interrupt the simulation system after a predetermined number of iterative solving cycles performed by the simulation system on each of the plurality of nanocells; receiving a set of second operating parameters from the simulation system, each of the second operating parameter corresponding to a respective nanocell of the plurality of nanocells; receiving a second set of first operating parameters determined based at least on the set of second operating parameters, each of the first operating parameter in the second set corresponding to a respective nanocell of the plurality of nanocells; and communicating the second set of first operating parameters to the simulation system for determining an updated second operating parameter of each nanocell of the plurality of nanocells.

In some embodiments, a computation system includes: a processor; a memory operatively coupled to processor, the memory storing executable instructions that, when executed by the processor, facilitate performance of operations, the operations comprising: receiving a signal indicative of a plurality of test impedance values obtained from a set of test electrochemical cells over a range of test operating parameters; determining an impedance function based on the test impedance values and the range of test operating parameters, the impedance function defined to estimate an operational impedance value of an electrochemical cell at a cell operating parameter; receiving a signal indicative of the cell operating parameter of the electrochemical cell; estimating an impedance value of the electrochemical cell at the cell operating parameter based on the impedance function; and generating an impedance signal indicative of the estimated impedance value.

### BRIEF DESCRIPTION OF THE DRAWINGS

FIG. 1A is a schematic illustration of a system for determining an impedance function based on test impedance values obtained from test electrochemical cells for a range of test operating parameters, which can be used to estimate the impedance of any electrochemical cell based on the operating parameters at which the electrochemical cell is operating, according to an embodiment.

FIG. 1B is a schematic illustration of an electrochemical cell, according to an embodiment.

FIG. 2 is a schematic block diagram of a computing system that may be included in the system of FIG. 1A, according to an embodiment.

FIG. 3 is a schematic flow chart of a method for determining an impedance function based on test impedance values obtained from test electrochemical cells for a range of test operating parameters, and using the impedance function to estimate an impedance value of an electrochemical cell based on the operating parameters of the electrochemical cell, according to an embodiment.

FIG. 4 is a plot of area specific impedance of a test electrochemical cell at various test operating temperatures and over a range of test SOC obtained via experimental analysis.

FIG. 5 is a plot of area specific impedance of two test electrochemical cells over a range of test SOC obtained via experimental analysis.

FIG. 6 is a plot of area specific impedance of a single electrochemical cell at 25% SOC over a temperature range from −20 degrees Celsius to 55 degrees Celsius obtained via experimental analysis.

FIG. 7 is a plot of area specific impedance of a single electrochemical cell at 80% SOC over a temperature range from −40 degrees Celsius to 60 degrees Celsius obtained via experimental analysis.

FIG. 8 is a schematic illustration of a system for generating a nanocell, causing a modeled electrochemical cell modeled in a simulation system to be divided into a plurality of nanocells, providing a first operating parameter of each of the nanocell to the simulation system, and interrupting the simulation system to provide an updated first parameter to the simulation system after a predetermined number of solving iterations, according to an embodiment.

FIG. 9 is a schematic block diagram of a computation system included in the system of FIG. 8, according to an embodiment.

FIG. 10A-10B are schematic flow charts of a method for generating a nanocell, causing a modeled electrochemical cell modeled in a simulation system to be divided into a plurality of nanocells, providing a first operating parameter of each of the nanocell to the simulation system, and interrupting the simulation system to provide an updated first parameter to the simulation system after a predetermined number of solving iterations, according to an embodiment.

FIG. 11A is an illustration of a pair of nanocells generated by the computation system of FIG. 8, according to an embodiment; FIG. 11B is an illustration of a plurality of the nanocells of FIG. 11A being arranged in a rectangular array; FIG. 11C is an illustration of two rectangular arrays of FIG. 11B being positioned to be stacked on top of each other; and FIG. 11D is an illustration of a large rectangular array of the plurality of nanocells of FIG. 11A being mapped onto a modeled electrochemical cell to divide the modeled electrochemical cell into the plurality of nanocells.

FIG. 12A is a schematic illustration of a portion of a modeled electrochemical cell modeled in a simulation system, with the simulation system dividing the modeled electrochemical cell into a plurality of finite element units (dotted lines) and the computation system of FIG. 8 dividing the electrochemical cell into a plurality of nanocells (solid lines), with each nanocell having a dimension such that each nanocell is mapped to a single corresponding finite element unit; FIG. 12B is similar to FIG. 12A with the difference that each nanocell has a dimension that is larger than each finite element unit such that each nanocell is mapped to a plurality of finite element units; and FIG. 12C is similar to FIGS. 12A-12B with the difference that each nanocell has a dimension that is smaller than each finite element unit such that multiple nanocells are mapped to each finite element unit.

FIG. 13 is perspective view of a modeled electrochemical cell stack modeled in a simulation system, according to an embodiment.

FIG. 14 shows the modeled electrochemical cell stack of FIG. 13 being dividing into a plurality of nanocells generated by the computation system of FIG. 8, according to an embodiment.

FIG. 15 is a plot of heat generated by one nanocell of the plurality of nanocells of FIG. 14 being determined by the simulation system at various iteration cycles, with the computation system of FIG. 8 interrupting the simulation system, and updating an impedance value of the nanocell after a predetermined number of iteration cycles.

FIG. 16 is a plot of variation in temperature of a nanocell of the plurality of nanocells over a period of time measured by the simulation system, which is used to update non-linear properties of the nanocell (e.g., impedance) after a predetermined number of iterative cycles performed by the simulation system.

FIG. 17 is a top view of the modeled electrochemical cell assembly of FIG. 14 with modeled current density across the modeled electrochemical cell being determined by the simulation system based on heat generation determined by the simulation system over various iteration cycles using resistance values of each of the plurality of nanocells provided by the computation system of FIG. 8.

FIG. 18 is a perspective view of a thick modeled electrochemical cell stack being modeled in a simulation system, and divided into a plurality of nanocells by the computation system of FIG. 8, with temperature across the modeled electrochemical cell assembly being determined by the simulation system using updated impedance values for each of the plurality of nanocells being provided to the simulation system by the computation system of FIG. 8.

FIG. 19 is a plot of temperature of a nanocell included in the modeled electrochemical cell of FIG. 18 having a maximum temperature among the plurality of nanocells. The temperature is determined by the simulation system based on updated impedance values of the nanocell being provided to the simulation system after predetermined iterative cycles by the computation system of FIG. 8. Initial temperature of the plurality of nanocells is −20 degree Celsius, ambient temperature is 25 degrees Celsius, and heat generated is 20 W/m² at C4 rate.

FIG. 20 is a plot of temperature of a nanocell included in the modeled electrochemical cell of FIG. 18 having a minimum temperature among the plurality of nanocells that the modeled electrochemical cell is divided into.

### DETAILED DESCRIPTION

Embodiments described herein relate to systems and methods for finite element modeling of electrochemical cells by generating nanocells that divide a modeled electrochemical cell into a plurality of nanocells or map a plurality of nanocells onto a modeled electrochemical cell. In particular, systems and methods described herein are related to generating a nanocell having a predetermined dimension, and dividing a finite element model of an electrochemical cell generated in, or provided to a finite element simulation system, into a plurality of nanocells having the predetermined dimension. First operating parameters corresponding to each of the plurality of nanocells are provided to the simulation system and model operating parameters may also be communicated to the simulation system allowing the simulation system to determine second operating parameters of each of the plurality of nanocells. The simulation system is interrupted after a predetermined number of iterations, iterative cycles, or solving cycles and second operating parameters are used to determine a new set of first operating parameters for each of the plurality of nanocells, allowing faster and more accurate finite element modeling of various parameters of the modeled electrochemical cell.

Embodiments described herein also relate to systems and methods for modeling or estimating electrochemical cell impedance by determining an impedance function from experimental data obtained from test electrochemical cells via experimentation. In particular, systems and methods described herein are related to determining of an impedance function based on test electrochemical cell data that is obtained by performing impedance measurements on various electrochemical cells at various test operating parameters. The impedance function is determined based on the test electrochemical cell data and test operating parameters, and can be used to estimate the impedance values of an electrochemical cell based on cell operating parameters at which the electrochemical cell is operating.

The impedance of electrochemical cells during operation is an indicator of heat generation. The amount of impedance in the electrochemical cells or portions of the electrochemical cell is proportional to heat generated by the electrochemical cell or portions of the electrochemical cell. Therefore, electrochemical cell impedance can be used as a predictor of heat generation in electrochemical cells. The impedance of electrochemical cells can vary based on various operating parameters of the electrochemical cells, for example, temperature and SOC. Therefore, it can be difficult to predict electrochemical cell impedance and thereby, the heat generated by electrochemical cells, at various operating parameters.

Some methods of determining impedance in electrochemical cells include conducting experiments on a large number of electrochemical cells at different cell operating parameters (e.g., range of temperatures, SOC, etc.) and experimentally determining the impedance of the electrochemical cells over the range. The determined impedance can then be used to estimate heat generation in models of electrochemical cells, for example, finite element models of electrochemical cells using commercial FEA simulation systems such as, for example, ANSYS®, COMSOL®, FUSION 360®, MATLAB®, ADINA®, NASTRAN®, etc., at the operating parameter at which the impedance value was determined. However, this requires performing a large number of experiments to cover a large number of operating parameters for which impedance values are obtained, which is expensive and time consuming. Moreover, this also includes running a large number of simulations and manually entering impedance values for each simulation which is time consuming, uses significant computational processing time and power, and can reduce accuracy.

Additionally, in modeling these electrochemical cells and determining the parameters of interest of modeled electrochemical cell(s), cell stack(s), or assembly(ies) including electrochemical cells, FEA simulation systems generally assume the operating parameters of the electrochemical cells to be uniform over the entire surface area or volume (e.g., across length, width, and/or thickness) of the modeled electrochemical cell. While this is acceptable for small electrochemical cells, large area electrochemical cells and cell assemblies experience substantial variations in their operating parameters across their area or volume. For example, operating parameters of the electrochemical cell, stack(s), or assemblies such as, for example, impedance, voltage, current, current density, SOC, etc., may vary across the surface area of the cell(s), stack(s), or assemblies, and such differences can be substantial over the surface area and volume of large electrochemical cell(s) and cell assembly(ies) including surface large electrochemical cells.

Known FEA simulation systems are generally capable of receiving input of single value for each of the operating parameters for the cell, stack(s), or assembly(ies) and assumes the input properties to be constant over the entire electrochemical cell. For example, known simulation systems are incapable of determining impedance of electrochemical cell(s), stack(s), or assembly(ies) which is a key parameter used by simulation systems to determine temperature across, and thereby, heat generated across the cell(s), stack(s), or assembly(ies). Therefore, as described, currently impedance of electrochemical cells is determined experimentally by performing a large number of electrochemical tests on several electrochemical cells to determine impedance of the electrochemical cells, or impedance at various portions of cell(s), stack(s), or assembly(ies) at different operating parameters, and entering the determined impedance values into the simulation system to determine the temperature, heat, and/or other parameters of the interest across the electrochemical cell(s), stack(s), or assembly(ies).

Because operating parameters (e.g., impedance) can vary substantially over the surface area of the cell(s), stack(s), or assembly(ies), the inability of the simulation systems to account for differences in input parameters across the cell(s), stack(s), or assembly(ies) can substantially reduce the accuracy of such FEA simulation systems for modeling electrochemical cells, particularly large electrochemical cells. To increase the accuracy, users have to perform a large number of experiments to determine variation in parameters such as impedance across the electrochemical cells, and then manually change input operating parameters, or model portions of electrochemical cell(s), stack(s), or assembly(ies) to increase accuracy. This can substantially increase number of experiments that have to be performed to determine input parameters for inputting to the simulation system, and substantially increases the computing power used by simulation systems to determine parameters of interest of the cell(s), stack(s), or assembly(ies). For example, as users change chemistry, size, and other parameters of the unit electrochemical cell(s), users generally have to run many physical tests to find out all the essential properties and parameters of the unit electrochemical cell(s) for thermal, fluid, electrical, structural, and/or chemical modeling and simulations.

In contrast, embodiments of the systems and methods described herein that are used to generate an impedance function that can be used to estimate electrochemical cell impedance at any cell operating parameter, and/or to generate nanocells and divide a modeled electrochemical cell(s), stack(s), or assembly(ies) modeled in a simulation system into the plurality of nanocells may provide one or more benefits including, for example: (1) allowing estimation of impedance of an electrochemical cell or nanocell having or operating at any operating parameter (e.g., temperature, thermal cycling, fluidity, life cycling, SOC, end of life (EOL), pressure, ambient temperature, having any or any other suitable parameter or any suitable combination thereof); (2) enabling determination of the impedance function using experimental impedance values obtained from a small number of electrochemical cells and/or using a small number of data points, thereby reducing experimental time and cost; (3) providing a single impedance function, or multiple impedance functions that can be used to estimate impedance of electrochemical cells or portions of large electrochemical cells over a large range of operating parameters; (4) enabling accurate estimations of impedance values to be communicated to simulation systems, such as FEA simulation systems, for generating more accurate computational models of heat generated by the electrochemical cells at various operating temperatures; (5) enabling division of modeled electrochemical cell into a plurality of nanocells whose dimensions are predetermined; (6) enabling varying of operating parameters of each of the plurality of nanocells individually based on modeled operating parameters experienced by the respective nanocell of the plurality of nanocells, thus increasing accuracy; (8) enabling interruption of iterative solution cycles being performed by a simulation system at predetermined intervals to allow updating of operating parameters of each nanocell, thus increasing accuracy; (9) allowing more accurate modeling of electrochemical cells while reducing the amount of physical electrochemical test data, such as tests on for different cells having different shapes, widths, lengths, thicknesses, and chemistries, that are generally collected for conventional modeling operations, thereby reducing experimental time, cost, and effort; (10) allowing integration with impedance estimation systems, thus enabling estimation of impedance for each nanocell based on the modeled operating parameter of the respective nanocell, and use of the estimated impedance for determining updated modeled operating parameters such as temperature of, and/or heat generated by each nanocell; and (11) reducing computational time, computational, speed, and computational power while increasing accuracy of the modeled operating parameters of electrochemical cells.

In some embodiments, the electrochemical cells described herein may include electrodes that can include conventional solid electrodes. In some embodiments, the solid electrodes can include binders. In some embodiments, electrodes described herein can include semi-solid electrodes. In some embodiments, semi-solid electrodes described herein can be made: (i) thicker (e.g., greater than 100 μm-up to 2,000 μm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes.

In some embodiments, the semi-solid electrodes included in the electrochemical cells described herein are binderless and/or do not use binders that are used in conventional battery manufacturing. Instead, the volume of the electrode normally occupied by binders in conventional electrodes, is now occupied by: (1) electrolyte, which has the effect of decreasing tortuosity and increasing the total salt available for ion diffusion, thereby countering the salt depletion effects typical of thick conventional electrodes when used at high rate, (2) active material, which has the effect of increasing the charge capacity of the battery, or (3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein. In some embodiments, the semi-solid electrodes described herein may include binders.

In some embodiments, the electrode materials described herein can include a flowable semi-solid or condensed liquid composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. The electrolyte can include an electrolyte solvent and an electrolyte salt. In some embodiments, the electrolyte solvent can include vinylene carbonate (VC), 1,3 propane sultone (PS), ethyl propionate (EP), 1,3-propanediol cyclic sulfate (PSA/TS), fluoroethylene carbonate (FEC), ethylene sulfite (ES), tris(2-ethylhexyl) phosphate (TOP), ethylene sulfate (DTD), diethyl carbonate (DEC), lithium difluorophosphate (LiPF₂O₂), butyl sultone (BuS), ethyl acetate (EA), maleic anhydride (MA), ethylene carbonate (EC), propylene carbonate (PC), dimethyl carbonate (DMC), ethyl methyl carbonate (EMC), or combinations thereof. In some embodiments, the electrolyte salt can include lithium bis(oxalate) borate (LiBOB), lithium hexafluorophosphate (LiPF₆), lithium bis(fluorosulfonyl)imide (LiFSI), or any combination thereof. Examples of battery architectures utilizing semi-solid suspensions are described in International Patent Publication No WO 2012/024499 (“the '499 publication”), filed Aug. 18, 2011 and titled “Stationary, Fluid Redox Electrode,” the entire disclosure of which is hereby incorporated herein by reference, and International Patent Publication No. WO 2012/088442 (“the '442 publication”), filed Dec. 22, 2011, and titled “Semi-Solid Filled Battery and Method of Manufacture,” the entire disclosure of which is hereby incorporated by reference.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

As used herein, the terms “activated carbon network” and “networked carbon” relate to a general qualitative state of an electrode. For example, an electrode with an activated carbon network (or networked carbon) is such that the carbon particles within the electrode assume an individual particle morphology and arrangement with respect to each other that facilitates electrical contact and electrical conductivity between particles and through the thickness and length of the electrode. Conversely, the terms “unactivated carbon network” and “unnetworked carbon” relate to an electrode wherein the carbon particles either exist as individual particle islands or multi-particle agglomerate islands that may not be sufficiently connected to provide adequate electrical conduction through the electrode.

As used herein, the terms “energy density” and “volumetric energy density” refer to the amount of energy (e.g., MJ) stored in an electrochemical cell per unit volume (e.g., L), including the electrodes, the separator, the electrolyte, the current collectors, and cell packaging. Unless otherwise noted, energy density and volumetric density include cell packaging.

As used herein, the term “impedance” is intended to include: “resistance” for direct current (DC) electrochemical cells, electrochemical cell assemblies, or circuits including such electrochemical cells; “AC impedance,” which is represented by the equation Z=R+jX, where R is resistance, j is “\sqrt{−1}”, and X is reactance; as well as “area specific impedance.” Resistance is the opposition to the flow of current in the electrochemical caused by the dissipative elements such as conductive material, current collectors, resistors, wires, or other components that convert electrical energy into heat. Reactance, on the other hand, arises from the reactive components of a circuit, such as capacitors and inductors, which store and release electrical energy. Reactance is frequency-dependent and can be either capacitive or inductive. Area specific impedance is the resistance of AC impedance of electrochemical cells or electrochemical cell assemblies per unit area of the cell or cell assemblies.

As used herein, the term “test electrochemical cells,” refers to physical electrochemical cells on which experiments are performed to determine test impedance values.

As used herein, the term “test operating parameters,” refers to experimental operating parameters including physical, electrical, and/or electrochemical parameters of the test electrochemical cells at which the experimental measurements of impedance of the test electrochemical cells are performed.

As used herein, the term “cell operating parameter,” refers to operating parameter(s) of a physical or modeled electrochemical cell for which an impedance value is being estimated using the impedance function(s) described herein.

As used herein, the term “nanocell” refers to a 3-dimensional spatial unit having known dimensions such that a plurality of units can be arranged in any suitable array, arrangement, or configuration to divide, or map onto an entire volume of a modeled electrochemical cell.

As used herein, the term “first operating parameter,” refers to an operating parameter(s) of a nanocell that is determined by a nanocell computation system and communicated to a simulation system.

As used herein, the term “second operating parameter,” refers to an operating parameter(s) of the nanocell determined by the simulation system based at least on the first operating parameter.

As used herein, the term “modeled operating parameter,” refers to operating parameters of a modeled electrochemical cell input into the simulation system by a user.

As used herein, the term “large electrochemical cell,” refers to electrochemical cells that have a dimension of at least 100 mm×100 mm.

It should be appreciated that while the systems and methods described herein are described with respect to modeling and simulating electrochemical cells, they are equally applicable to modeling and simulating other electrical or electronic systems (e.g., capacitors, super capacitors, electronics circuits, printed circuit boards, processors, etc.), as well as non-electrochemical models (e.g., mechanical structures and/or assemblies), and general FEA analysis. All such implementations are contemplated and should be considered to be within the scope of the present application.

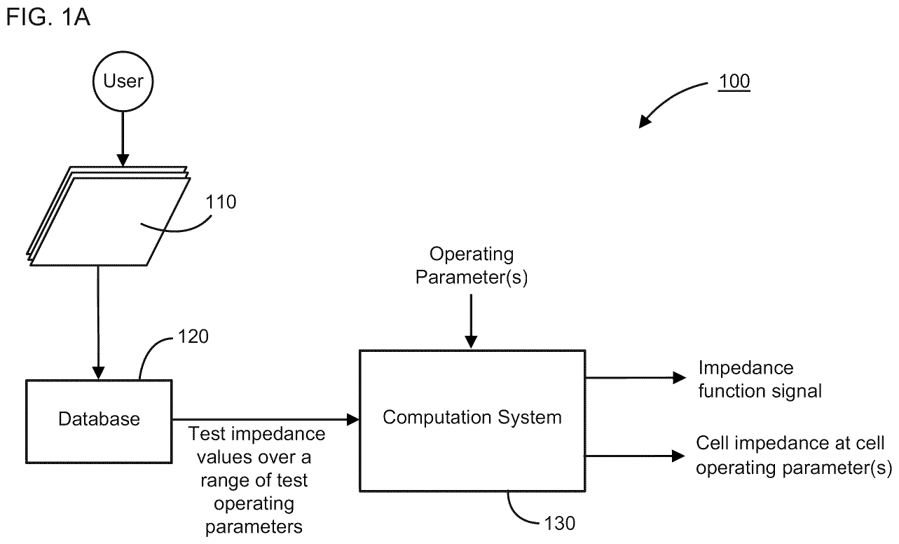

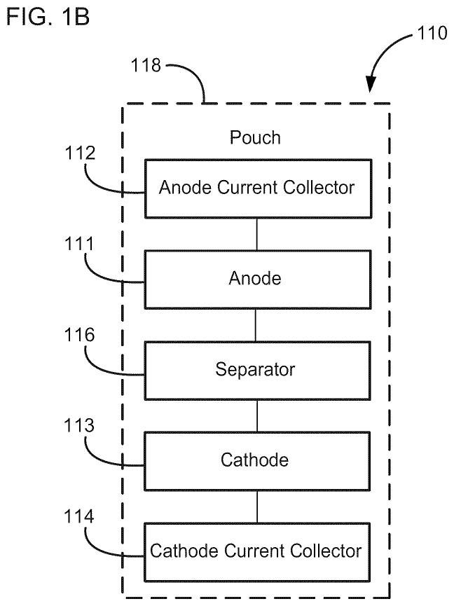

Referring now to FIG. 1A, a system 100 is shown that can be used or employed for determining an impedance function(s) based on test impedance values obtained from test electrochemical cells 110 (also referred to herein as “cells 110”) for a range of test operating parameters, which can be used to estimate the impedance of any electrochemical cell based on the operating parameters at which the electrochemical cell is operating, according to an embodiment. In some embodiments, the system may include at least a database 120 and a computation system 130. In some embodiments, the system may include other components that may be desired to perform operations of the system 100. Such components may include, but are not limited to a communication system for communication information to and/or from the computation system 130, and a simulation system (e.g., a FEA simulation system) configured to model impedance of an electrochemical cell(s) or portions thereof based on one or more impedance functions received from the computation system 130, as described herein.

The database 120 may be configured to receive test impedance values obtained from a set of test electrochemical cells 110 over a range of test operating parameters. The database 120 may include any suitable database or storage system configured to store test impedance values (e.g., resistance, area specific resistance, impedance, or area specific impedance) obtained from the test electrochemical cells 110 and the range of test operating parameters over which the test impedance values were obtained. The test impedance values may be stored in the database 120 in the form of values, tables, charts, matrices, binary information, or in any other suitable format. The database 120 may include any suitable database such as, for example, a relational database, a NoSQL database, object oriented database, a hierarchical database, a network database, a columnar database, a time-series database, a spatial database, any other suitable database, or any other suitable combination thereof. In some embodiments, the database 120 may be included in a local server. In other embodiments, the database 120 may be included in a remote server, or a cloud server. In some embodiments, the database 120 may include any suitable data storage device such as, for example, hard disk drives, solid state drives, network attached storage, storage area network, cloud storage, in-memory storage, hybrid storage, any other suitable storage or any suitable combination thereof.

In some embodiments, the test impedance values may be obtained by a user performing charge/discharge cycles over a range of test operating parameters, and/or measuring impedance of the set of test electrochemical cells 110 over the range of test operating parameters. The user may perform the experiments using any suitable experimental setup to obtain the test impedance values such as, for example, electrochemical cell analyzers that can be used to determine voltage, resistance, capacity and/or other parameters to assess overall health and performance of the cells 110, cell testers that can be used to determine state of charge and remaining capacity of the cells 110, electrochemical cell cyclers for performing charge/discharge cycles on the cells 110 to determine cell capacity, performance, and/or life cycle, impedance testers that can be used to determine impedance, health, and/or aging characteristics of the electrochemical cells 110, cell load testers that can be used to determine how well an electrochemical cell maintains voltage and capacity under load conditions, thermal chambers that may be used to create controlled temperature conditions for testing the electrochemical cells under different temperature conditions, battery capacity testers that can be used to determine amount of energy that can be stored by the cells 110, battery voltage meters, battery data acquisition systems, any other suitable testing equipment or experimental setup, or any suitable combination thereof 100591 in some embodiments, the range of test operating parameters may include, but are not limited to a dimension, a temperature, a SOC, a number of charge and discharge cycles, a pressure, a chemical composition, a porosity, an ion speed, a degradation level, a cell end of life, a joule heating, or a reactive heating of the test electrochemical cell 110. For example, in some embodiments, the test operating parameter may include a dimension of the test electrochemical cells, for example, a width, a length, and/or a thickness of the electrochemical cells 110 or otherwise an anode and/or a cathode (e.g., the anode 1 and the cathode 113 as shown described in detail with respect to FIG. 1B). In some embodiments, the length and/or width of the electrochemical cells 110 or the anode 111 may be in a range of about 10 mm to about 2 meters, inclusive.

In some embodiments, the test electrochemical cells 110 can include conventional electrodes (e.g., solid electrodes with binders). In some embodiments, the thickness of the conventional electrodes can be in the range of about 20 μm to about 100 μm, about 20 μm to about 90 μm, about 20 μm to about 80 μm, about 20 μm to about 70 μm, about 20 μm to about 60 μm, about 25 μm to about 60 μm, about 30 μm to about 60 μm, about 20 μm to about 55 μm, about 25 μm to about 55 μm, about 30 μm to about 55 μm, about 20 μm to about 50 μm, about 25 μm to about 50 μm, or about 30 μm to about 50 μm, inclusive of all values and ranges therebetween. In some embodiments, the thickness of the conventional electrodes can be about 20 μm, about 25 μm, about 30 μm, about 35 μm, about 40 μm, about 45 μm, about 50 μm, about 55 μm, or about 60 μm, inclusive of all values and ranges therebetween.

In some embodiments, the anode of the test electrochemical cells 110 (e.g., the anode 111) can have a thickness of at least about 20 μm, at least about 30 μm, at least about 40 μm, at least about 50 μm, at least about 60 μm, at least about 70 μm, at least about 80 μm, at least about 90 μm, at least about 100 μm, at least about 110 μm, at least about 120 μm, at least about 130 μm, or at least about 140 μm. In some embodiments, the anode can have a thickness of no more than about 150 μm, no more than about 140 μm, no more than about 130 μm, no more than about 120 μm, no more than about 110 μm, no more than about 100 μm, no more than about 90 μm, no more than about 80 μm, no more than about 70 μm, no more than about 60 μm, no more than about 50 μm, or no more than about 30 μm. Combinations of the above-referenced thicknesses of the anode are also possible (e.g., at least about 20 μm and no more than about 150 μm or at least about 50 μm and no more than about 100 μm), inclusive of all values and ranges therebetween. In some embodiments, the anode can have a thickness of about 20 μm, about 30 μm, about 40 μm, about 50 μm, about 60 μm, about 70 μm, about 80 μm, about 90 μm, about 100 μm, about 110 μm, about 120 μm, about 130 μm, about 140 μm, or about 150 μm.

In some embodiments, the cathode of the test electrochemical cells 110 (e.g., the cathode 113) can have a thickness of at least about 50 μm, at least about 60 μm, at least about 70 μm, at least about 80 μm, at least about 90 μm, at least about 100 μm, at least about 110 μm, at least about 120 μm, at least about 130 μm, at least about 140 μm, at least about 150 μm, at least about 200 μm, at least about 250 μm, at least about 300 μm, at least about 350 μm, at least about 400 μm, or at least about 450 μm. In some embodiments, the cathode can have a thickness of no more than about 500 μm, no more than about 450 μm, no more than about 400 μm, no more than about 350 μm, no more than about 300 μm, no more than about 250 μm, no more than about 200 μm, no more than about 150 μm, no more than about 140 μm, no more than about 130 μm, no more than about 120 μm, no more than about 110 μm, no more than about 100 μm, no more than about 90 μm, no more than about 80 μm, no more than about 70 μm, or no more than about 60 μm. Combinations of the above-referenced thicknesses of the cathode are also possible (e.g., at least about 50 μm and no more than about 500 μm or at least about 100 μm and no more than about 300 μm), inclusive of all values and ranges therebetween. In some embodiments, the cathode can have a thickness of about 50 μm, about 60 μm, about 70 μm, about 80 μm, about 90 μm, about 100 μm, about 110 μm, about 120 μm, about 130 μm, about 140 μm, about 150 μm, about 200 μm, about 250 μm, about 300 μm, about 350 μm, about 400 μm, about 450 μm, or about 500 μm.

In some embodiments, the test electrochemical cells 110 can have a thickness of at least about 100 μm, at least about 150 μm, at least about 200 μm, at least about 250 μm, at least about 300 μm, at least about 350 μm, at least about 400 μm, at least about 450 μm, at least about 500 μm, at least about 550 μm, at least about 600 μm, at least about 650 μm, at least about 700 μm, at least about 750 μm, at least about 800 μm, at least about 850 μm, at least about 900 μm, or at least about 950 μm. In some embodiments, the test electrochemical cells 110 can have a thickness of no more than about 1,000 μm, no more than about 950 μm, no more than about 900 μm, no more than about 850 μm, no more than about 800 μm, no more than about 750 μm, no more than about 700 μm, no more than about 650 μm, no more than about 600 μm, no more than about 550 μm, no more than about 500 μm, no more than about 450 μm, no more than about 400 μm, no more than about 350 μm, no more than about 300 μm, no more than about 250 μm, no more than about 200 μm, or no more than about 150 μm. Combinations of the above-referenced thicknesses of the test electrochemical cells 110 are also possible (e.g., at least about 100 μm and no more than about 1,000 μm or at least about 200 μm and no more than about 500 μm), inclusive of all values and ranges therebetween. In some embodiments, test electrochemical cells 110 can have a thickness of about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, or about 1,000 μm.

The range of temperatures at which the test impedance values are obtained may be in a range of about −50 degrees Celsius to about 80 degrees Celsius, and may correspond to the range of operating temperatures that the electrochemical cells may experience during regular operation. In some embodiments, the range of temperatures may be in a range of about −40 degrees Celsius to about 60 degrees Celsius. In some embodiments, the range of temperatures may be in a range of about −30 degrees Celsius to about 55 degrees Celsius. In some embodiments, the range of temperatures may be in a range of about −25 degrees Celsius to about 55 degrees Celsius. In some embodiments, the range of temperatures may be in a range of about −20 degrees Celsius to about 55 degrees Celsius. In some embodiments, the temperature at which the test impedance values are determined may be −60, −50, −40, −30, −20, −10, 0, 10, 20, 30, 40, 50, 60, 70, or 80 degrees Celsius, inclusive.

In some embodiments, the test operating parameter may include a range of SOC of the test electrochemical cells 110 at which the test impedance values are measured. The SOC refers to the amount of electrical energy remaining in the test electrochemical cells 110 at a given time, expressed as a percentage of the total capacity of the test electrochemical cells 110, i.e., how much charge the electrochemical cells 110 currently hold relative to their maximum capacity. The SOC may be determined by the user based on an open circuit voltage, coulomb counting, impedance tracking, or hybrid methods that combine various SOC measurement techniques to determine the SOC of the test electrochemical cells 110. The SOC may be in a range of 0% to 100% (e.g., 0%, 10%, 20%, 30%, 40%, 50%, 60%, 70%, 80%, 90, or 100%, inclusive) 100661 in some embodiments, the test operating parameter may include a range of pressures exerted on the electrochemical cells 110 and the test impedance values measured over the range of pressures. In some embodiments, the range of pressures may be in a range of about 0 MPa to about 0.15 MPa inclusive (e.g., about 0.0, 0.01, 0.02, 0.03, 0.04, 0.05, 0.06, 0.07, 0.08, 0.09, 0.1, 0.11, 0.12, 0.13, 0.14, or 0.15 MPa, inclusive). In some embodiments, the pressure may be in range of about 0.01 MPa to about 0.14 MPa, inclusive. In some embodiments, the pressure is in a range of about 0.03 MPa to about 0.13 MPa, inclusive. In some embodiments, the pressure is in a range of about 0.05 MPa to about 0.13 MPa inclusive. In some embodiments, the pressure is in range of about 0.07 MPa to about 0.13 MPa, inclusive. In some embodiments, the pressure is in a range of about 0.09 MPa to about 0.13 MPa, inclusive. Combinations of the above-referenced pressures are also possible (e.g., at least about 0.01 MPa and no more than about 0.14 MPa, or at least about 0.05 MPa and no more than about 0.13 MPa, inclusive) and should be considered to be within the scope of the present disclosure.

In some embodiments, the test operating parameter may include a chemical composition of the cells 110, for example, the composition of active materials, conductive materials, additives, electrolytes, tillers, etc., used to form the electrochemical cells. In some embodiments, the anode and/or the cathode of the test electrochemical cells 110 may include conventional electrodes (e.g., electrodes that include binders). In some embodiments, the anode may include a graphite or an anode formed of a high capacity material (e.g., silicon). In some embodiments, the anode and/or the cathode of the test electrochemical cells 110 may include a semi-solid electrode, as described herein and with respect to FIG. 1B.

In some embodiments, the operating parameter may include a range of porosities of the anode and/or cathode of the test electrochemical cells 110. In some embodiments, the porosity may be in range of about 1% to about 60%, inclusive. In some embodiments, the porosity may be in a range of about 2% to about 50%, inclusive. In some embodiments, the porosity may be in range of about 3% to about 40%, inclusive. In some embodiments, the porosity may be in a range of about 4% to about 30% inclusive. In some embodiments, the porosity may be in range of about 5% to about 20%, inclusive. In some embodiments, the porosity may be in range of about 0% to about 5%, inclusive. In some embodiments, the porosity may be in range of about 2% to about 10%, inclusive. In some embodiments, the porosity may be in range of about 3% to about 15%, inclusive. In some embodiments, the porosity may be in range of about 4% to about 20%, inclusive.

In some embodiments, the porosity may be at least about 1%. In some embodiments, the porosity may be at least about 2%, in some embodiments, the porosity may be at least about 3%. In some embodiments, the porosity may be at least about 5%. In some embodiments, the porosity may be at least about 10%. In some embodiments, the porosity may be at least about 15%. In some embodiments, the porosity may be at least about 20%. In some embodiments, the porosity may be at least about 25%. In some embodiments, the porosity may be at least about 30%. In some embodiments, the porosity may be at most about 60%. In some embodiments, the porosity may be at most about 50%. In some embodiments, the porosity may be at most about 40% In some embodiments, the porosity may be at most about 30%. In some embodiments, the porosity may be in about 1, 2, 3, 4, 5, 10, 15, 20, 25, 30, 35, 40, 45, 50, 55, or 60%, inclusive. Combinations of the above-referenced range of porosities of the test electrochemical cells 110 over which the test impedance values are determined are also possible (e.g., at least about 1% and no more than about 60%, or at least about 2% and no more than about 50%, inclusive) and should be considered to be within the scope of the present disclosure.

In some embodiments, the range of test operating parameters may include an ion speed of ions (e.g., Li ions) included in the test electrochemical cells 110 (e.g., in the cathode 113), or ionic conductivity of the test electrochemical cells 110. The speed of ions in electrochemical cells 110 can vary depending on several factors, including the type of ion, the electrolyte composition, temperature, and the presence of any barriers or restrictions within the cells 110. The speed of ion movement in the electrolyte included in the cells 110 may be influenced by the concentration of ions and the electrical potential across the cells 110. When a potential difference (voltage) is applied to the cells 110, ions migrate or drift through the electrolyte to balance the charge and establish equilibrium.

In some embodiments, the test operating parameter may include the degradation level of the cells 110. The degradation level of the cells 110 refers to the extent deterioration or loss in performance of the test electrochemical cells 110 over time, and can depend on various factors including the type of electrochemical cell, cell chemistry, cell design, operating conditions, and usage patterns Common degradation factors may include, but are not limited to, capacity fade (i.e., gradual loss of the cell charge storage capacity due to formation of solid electrolyte interphase (SEI), gradual loss of active materials, or changes in the structure and morphology of electrode materials), cycling degradation (i.e., cell performance degradation due to the repeated charge and discharge cycles of electrochemical cells that can cause small amounts of irreversible degradation, leading to capacity loss and reduced performance over time due to mechanical stress, electrolyte reactions, electrode material degradation, and/or side reactions), calendar aging (i.e., degradation that occurs due to factors such as self-discharge, chemical reactions between the cell components, and the breakdown of active materials over time), side reactions (e.g., lithium plating, electrolyte decomposition, and gas evolution during regular operation), temperature effects (e.g., due to operation at extremely high or low temperatures that can promote undesired chemical reactions, increase electrolyte decomposition, accelerate electrode material degradation, and cause thermal stress at high temperatures, or lead to reduced ion mobility, decreased reaction rates, and increased resistance within the cell at low temperatures), and/or mechanical stress (e.g., due to vibration, shock, or physical deformation which can lead to internal short circuits, loss of active material contact, and compromised cell performance).

In some embodiments, the test operating parameter may include the end of life of the cells 110, which refers to the point in the electrochemical cell 110's lifespan when its performance has degraded to a level where it is no longer suitable or effective for its intended application. At this stage, the cell 110 may no longer meet its rated capacity, voltage, power output, or other performance metrics. In some embodiments, the test operating parameter may include a joule heating and/or reactive heating of the cell 110 (e.g., resistive heating or ohmic heating) that refers to the heat generated within the electrochemical cell 110 due to the resistance encountered by the flow of electric current through the cell 110's component. When a current passes through the cell 110, the electrical energy is converted into heat energy as it encounters resistance in the conductive elements of the cell 110. Joule heating can lead to temperature rise, efficiency loss, and/or heat dissipation. On the other hand, reactive heating refers to the heat generation that occurs due to chemical reactions within an electrochemical cell. Unlike joule heating, which arises from the resistance encountered by electric current, reactive heating is a result of the exothermic or heat-releasing chemical reactions taking place during the cell's operation. Joule heating and reactive heating may both contribute to the range of test temperatures of the test electrochemical cells 110 over which the test impedance values are determined.

The electrochemical cells 110 may include any suitable electrochemical cell configured to store electrical energy and deliver electrical energy on demand. For example, FIG. 1B is a schematic block diagram of a test electrochemical cell 110 that may be used in the set of test electrochemical cells 110 to determine the test impedance values, according to an embodiment. In some embodiments, each of the test electrochemical cells 110 used to determine the test impedance values may be substantially similar to each other. In some embodiments, at least a portion of the test electrochemical cells 110 included in the set of test electrochemical cells 110, may be different from another portion of the set of test electrochemical cells 110 (e.g., having different composition, have different size, different combination of anode or cathode, different separators, etc.). In some embodiments, the test electrochemical cells 110 can include prismatic cells. While FIG. 113 shows a particular embodiment of a test electrochemical cell 110 that may be used to determine the test impedance values, this is for illustrative purposes only and the test electrochemical cells 110 can include any other electrochemical cells having any suitable structure or formulation. All such embodiments are envisioned and should be considered to be within the scope of the present disclosure.

As shown, the test electrochemical cell 110 includes an anode 111 disposed on an anode current collector 112, a cathode 113 disposed on a cathode current collector 114, and a separator 116 disposed between the anode 111 and the cathode 113. The anode 111, the anode current collector 112, the cathode 113, the cathode current collector 114, and the separator 116 may disposed in a pouch 118, for example, an aluminum pouch, a mica pouch, a polymer pouch, etc. In some embodiments, the pouch 118 may be excluded.

The anode 111 includes an anode active material. In some embodiments, the anode 111 can include an anode conductive material. In some embodiments, the anode 111 can include a semi-solid anode. In some embodiments, the anode 111 may include a high capacity material such as, for example, silicon, bismuth, boron, gallium, indium, zinc, tin, antimony, aluminum, titanium oxide, molybdenum, germanium, manganese, niobium, vanadium, tantalum, iron, copper, gold, platinum, chromium, nickel, cobalt, zirconium, yttrium, molybdenum oxide, germanium oxide, silicon oxide, silicon carbide, any other high capacity materials or alloys thereof, and any combination thereof. The anode 111 is disposed on the anode current collector 112 and is configured to receive electrons therefrom. In some embodiments, the anode current collector 112 can be composed of copper, aluminum, nickel, titanium, or any other suitable conductive material, or any suitable combination thereof.

The cathode 113 includes a cathode active material. In some embodiments, the cathode 113 can include a cathode conductive material. In some embodiments, the cathode 113 can include a semi-solid cathode. The cathode 113 is disposed on the cathode current collector 114 and is configured to communicate electrons thereto. In some embodiments, the cathode current collector 114 can include an aluminum or any other suitable current collector material.

The separator 116 can include any suitable separator that acts as an ion-permeable membrane. In other words, the separator 116 allows exchange of ions while maintaining physical separation of the cathode 113 and the anode 111. For example, the separator 116 can be any conventional membrane that is capable of ion transport. In some embodiments, the separator 116 is a liquid impermeable membrane that permits the transport of ions therethrough, namely a solid or gel ionic conductor. In some embodiments the separator 116 is a porous polymer membrane infused with a liquid electrolyte that allows for the shuttling of ions between the cathode 113 and anode 111 electroactive materials, while preventing the transfer of electrons.

In some embodiments, the separator 116 can be a microporous membrane that prevents particles forming the positive and negative electrode compositions from crossing the membrane. For example, the membrane materials can be selected from polyethylene oxide (PEO) polymer in which a lithium salt is complexed to provide lithium conductivity, or NAFION™ membranes which are proton conductors. For example, PEG based electrolytes can be used as the membrane, which is pinhole-free and a solid ionic conductor, optionally stabilized with other membranes such as glass fiber separators as supporting layers. PEO can also be used as a slurry stabilizer, dispersant, etc. in the positive or negative redox compositions. PEO is stable in contact with typical alkyl carbonate-based electrolytes. This can be especially useful in phosphate-based cell chemistries with cell potential at the positive electrode that is less than about 3.6 V with respect to Li metal. In some embodiments, the separator 116 can include polyethylene, polypropylene, polyimide, or any combination thereof. In some embodiments, the separator 116 can be made from a ceramic such as alumina. In some embodiments, the separator 116 can be made from a suitable polymer with ceramic particles dispersed within the separator 116 or deposited on one or both surfaces of the separator 116.

In some embodiments, pouch 118 can include one or more films, for example, a first and second film that can be coupled to each and in some embodiments, at least a portion of the separator 116, to define an internal volume within which components of the test electrochemical cell 110 are disposed. While not shown, the test electrochemical cell 110 or any other electrochemical cell included in the set of test electrochemical cells 110 may include a vent or venting mechanism (e.g., weak sealing regions, piercing mechanisms, etc.) to allow gases that may build up in the test electrochemical cell 110 during operation or as a result of damage to the test electrochemical cell 110 to selectively escape from the test electrochemical cell 110, for example, in response to a gas pressure within the pouch 118 exceeding a predetermined pressure threshold.

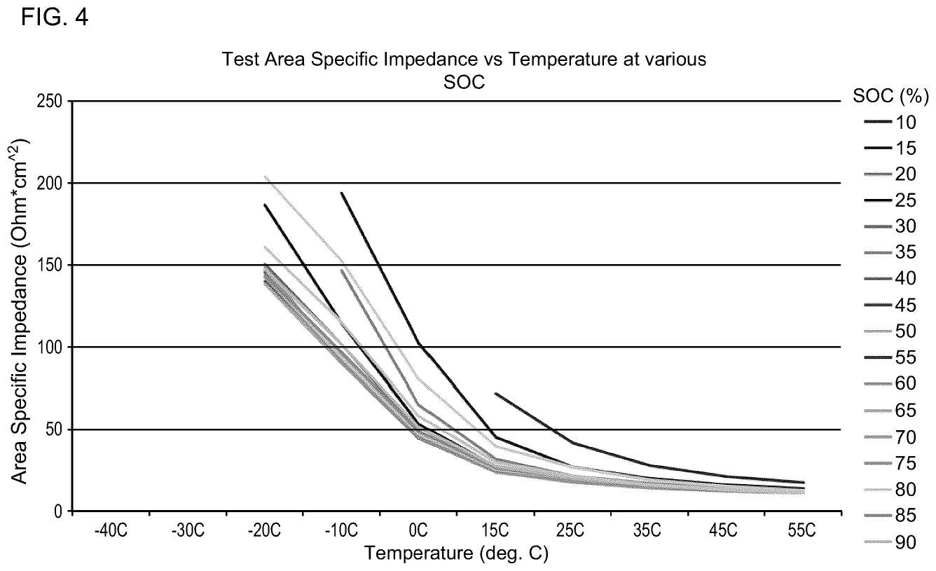

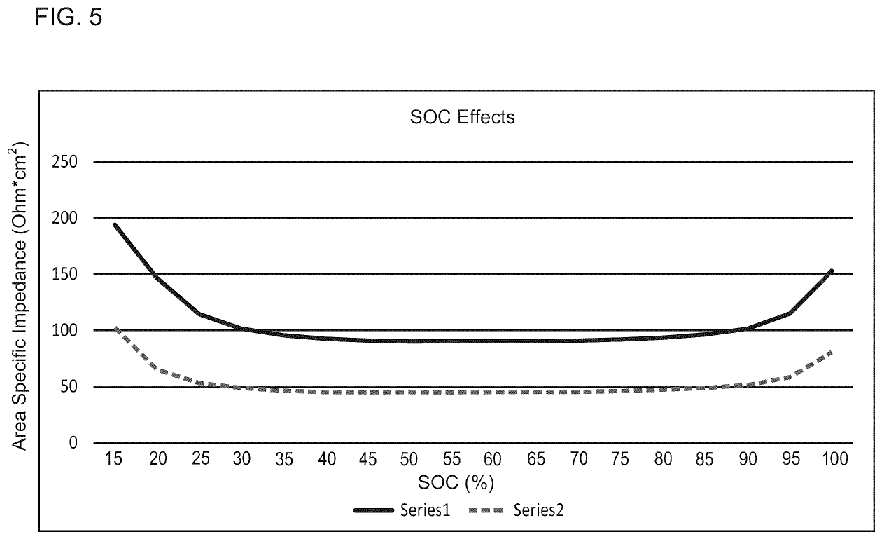

Referring again to FIG. 1A, the computation system 130 is configured to receive a signal indicative of the test impedance values from the set of test electrochemical cells over the range of test operating parameters, for example, from the database 120. The data corresponding to the test impedance values may be in the form of charts, plots, or values stored in tables or matrices. For example, FIG. 4 is a plot of area specific impedance of a test electrochemical cell(s) at test operating temperatures in range of −20 degrees Celsius to 55 degrees Celsius, and over a range of test SOC from 10% to 90% obtained via experimental analysis by a user, which may be received by the computation system 130.

To obtain the test impedance values represented by the plot of FIG. 4, a user may measure (e.g., using any of the testing equipment described herein) area specific impedance of one or more test electrochemical cells (e.g., the test electrochemical cells 110) at various temperatures and SOC of the test electrochemical cells. For example, FIG. 5 is a plot of area specific impedance of the test electrochemical cells over a range of test SOC obtained via experimental analysis, as described herein. While FIG. 5 shows the area specific impedance as being measured at SOCs ranging from 15% to 100%, the area specific impedance or impedance of the test electrochemical cells 110 may be measured from about 0% to about 100%, inclusive, or any other suitable range. Different test electrochemical cells may have different impedances at a given temperature depending on their chemistry or other test operating parameters, as described herein. Moreover, electrochemical cells can also have different impedance values over a range of SOC at different operating temperatures. For example, as shown in FIG. 5, the series 1 test electrochemical cell that was operated at about −10 degrees Celsius demonstrated an overall higher specific impedance at SOC in a range of 15% to 100%, than the series 2 test electrochemical cell that was operated at about 0 degrees Celsius over the same SOC range.

In some embodiments, the test impedance values may be determined for electrochemical cell assemblies that may include a pouch(s), a housing(s), a circuit(s), any other accessory, or any suitable combination thereof. In such embodiments, the impedance functions determined by the computation system 130, as described herein would correspond to such test electrochemical cell assemblies and can be used to estimate impedance values of electrochemical cell assemblies that are similar to the test electrochemical cell assemblies but whose impedance values are unknown.

As shown in FIG. 4, the test impedance values are also obtained at test operating temperatures in a range of −20 degrees Celsius to 55 degrees Celsius at various SOC in a range of 10% to 90% of the one or more test electrochemical cells as the impedance values of the test electrochemical cells plotted vs the temperature. As illustrated in FIG. 4, the test impedance values generally decrease with increasing temperature, but the impedance values are also impacted by the SOC of the test electrochemical cells.

The computation system 130 may be configured to determine an impedance function based on the test impedance values and the range of test operating parameters, the impedance function defined to estimate an operational impedance value of an electrochemical cell at a cell operating parameter. For example, in some embodiments, the test operating parameters may include a range of test temperature values and a range of test SOC values at which the test impedance value are determined, and the computation system 130 may be configured to determine the impedance function based on the test impedance values measured at the various test temperatures and test SOC from the test electrochemical cells 110. In some embodiments, the impedance function may include a single impedance function that may be used to estimate the operational impedance value of an electrochemical cell (e.g., a physical or modeled electrochemical cells) at the cell operating parameter (e.g., operating temperature, SOC, dimension, pressure chemical composition, porosity, ion speed, degradation level, cell end of life, cycling, joule heating, reactive, heating, any other cell operating parameter, or any suitable combination thereof) In some embodiment, the impedance function may include a set of impedance functions corresponding to various SOC, temperatures, or other test operating parameters (e.g., tens, hundred, thousands, or even millions of impedance functions based on varying test operating parameters), that may be used to estimate the operational impedance value of an electrochemical cell at cell operating parameter that corresponding to the test SOC, test temperature, any other test operating parameter, or a combination thereof.

In some embodiments, the impedance function determined by the computation system 130 includes a cubic order polynomial function. In some embodiments, the cubic polynomial function includes the following equation

$${R}_{T} = {{P}_{o} ( 1 - u )}^{3} + 3 {P}_{1} {u ( 1 - u )}^{2} + {P}_{2} {u}^{2} ( 1 - u ) + {P}_{3} {u}^{3} \qquad ( 1 )$$

where R_{T} is the impedance value at a specific cell operating temperature, P₀, P₁, P₂, and P₃ are test impedance values control points at various temperatures obtained from the set of test electrochemical cells 110 at a SOC value within the range of SOC values, and u is a normalization parameter for temperature. In some embodiments, the normalization parameter for temperature u may be defined by the following equation.

$$u = \frac{T + 20}{50} \qquad ( 2 )$$

where T is the cell operating temperature at which the electrochemical cell is operating.

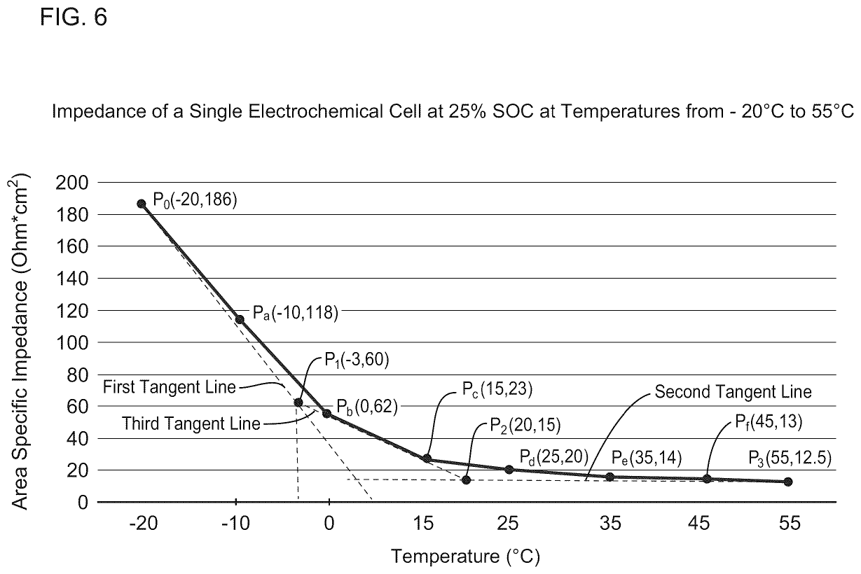

For example, FIG. 6, is a plot of area specific impedance obtained from a single test electrochemical cell at 25% SOC over a temperature range from −20 degrees Celsius to 55 degrees Celsius. At −20 degrees Celsius, the area specific impedance is 186 ohm·cm² and is equal to P₀ in equation 1. At 55 degrees Celsius, the area specific impedance is 12.5 ohm·cm² that corresponds to P₃ in equation 1. As shown in FIG. 6, the plot also includes test impedance values obtained at −10 degrees Celsius (Pₐ), 0 degrees Celsius (P_{b}), 15 degrees Celsius (P_{c}), 25 degrees Celsius (P_{d}), 35 degrees Celsius (Pₑ), and 45 degrees Celsius (P_{f}). In some embodiments, to obtain P₂ and P₃, the computations system 130 is configured to draw, define, extend, or extrapolate a first tangent line from P₀ towards P₃ or the x-axis, and a second tangent line from P₃ towards P₀ or the y-axis. The computation system 130 is further configured to draw, define, extend, or extrapolate a third tangent line which crosses each of P_{b} and Pₑ, intersects the first tangent line at a first end thereof, and intersects the second tangent line at a second end thereof. The computation system 130 is configured to select a first point at which the third tangent line intersects the first tangent line as P₁, in this case corresponding to a test impedance value of 60 ohm·cm² at −3 degrees Celsius, and select a second point at which the third tangent line intersects the second tangent line as P₂, in this case corresponding to a test impedance value of 15 ohm·cm² at 20 degrees Celsius.

P_{b} and Pₑ may be selected by the computation system 130 for the third tangent line because while the test impedance values decreases substantially linearly from P₀ to P_{b}, the rate of decrease of the test impedance values changes substantially form P_{b} to Pₑ. The test impedance values however, decreases substantially linearly from P_{b} to Pₑ. Therefore, selecting P_{b} and Pₑ for the third tangent line, allows the first intersection point and the second intersection point to be closest to the actual area impedance vs. temperature curve shown in FIG. 6, thereby providing a reasonable estimate of the test impedance values at control points P₁ and P₂.

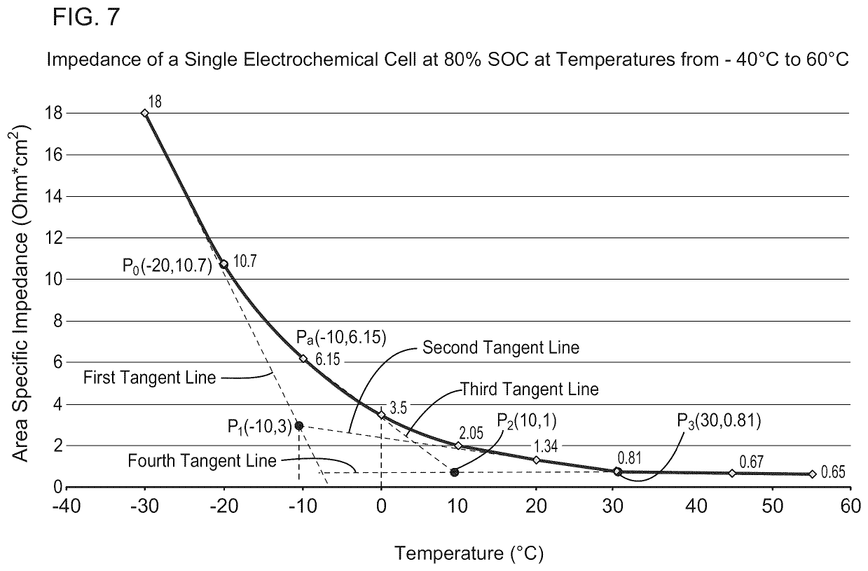

FIG. 7 is a plot of area specific impedance of a single electrochemical cell at 80% SOC over a temperature range from −40 degrees Celsius to 60 degrees Celsius. At −20 degrees Celsius, the area specific impedance is 10.7 ohm·cm² and is equal to P₀ in equation 1. At 30 degrees Celsius, the area specific impedance is 0.81 ohm·cm² that corresponds to P₁ in equation 1 Different from FIG. 6, the computation system may be configured to select P₁ and P₂ in equation as an estimate of the test impedance values at −10 degrees Celsius and 10 degrees Celsius, for example, to provide a more accurate estimate of impedance values of an electrochemical cell. For example, the computation system 130 may be configured to draw, define, extend, or extrapolate a first tangent line from P₀ towards P₃ or the x-axis, and a second tangent line from P₃ towards P₀ such that it intersects the first tangent line at a point corresponding to −10 degrees Celsius, corresponding to an estimated test impedance value of 3 ohm·cm² that is selected as P₁ in equation 1 To determine P₂, the computation system 130 may be configured to draw a third tangent line from Pₐ that corresponds to a test impedance value obtained at −10 degree Celsius, towards P₃, and a fourth tangent line from P₃ towards Pₐ such that the fourth tangent line intersects the third tangent line at a point corresponding to 10 degrees Celsius and the estimated test impedance value at this point, which is equal to 1 ohm·cm² is selected as P₂ in equation 1 by the computation system 130. For example, the cubic order polynomial function for determining an impedance value of an electrochemical cell at 80% SOC and for a temperature in a range of −40 degrees Celsius to 60 degrees determined from FIG. 7 can be defined by equation 3 as follows:

$${R}_{T} = 10.7 {( 1 - u )}^{3} + 9 {u ( 1 - u )}^{2} + 3 {u}^{2} ( 1 - u ) + 0.81 {u}^{3}$$

In some embodiments, the computation system 130 may be configured to determine the impedance function so that it includes a fourth order polynomial function. For example, based on the test impedance values obtained for various SOC over a temperature range, for example, as represented by the plots of FIG. 6 and FIG. 7, the computation system 130 may determine a fourth order polynomial as the impedance function. In some embodiment, the fourth order polynomial function may include the following equation:

$${R}_{T} = α {T}^{4} + {bT}^{3} + {cT}^{2} + dT + e \qquad ( 4 )$$

where R_{T} is the impedance value at a cell operating temperature at which the electrochemical cell is operating, a, b, c, d, and e are constants obtained from the test impedance values, and T is the cell operating temperature at which a physical or modeled electrochemical cell is operating. In some embodiments, a, b, c, d, and e, may be obtained by taking four test impedance values and corresponding test temperature vales from test impedance vs temperature plots (e.g., any of the plots shown in FIGS. 4-7) and inserting them into equation 4 so as to obtain multiple fourth order polynomial equations. The obtained multiple equations are then solved by the computation system 130 to obtain the values for a, b, c, d, and e in equation 4.

In some embodiments, the computation system may be configured to determine an impedance function which includes the following equation:

$$R = {R}_{T} ( {C}_{F} + {S}_{F} ) \qquad ( 5 )$$

where R_{T}=aT⁴+bT³+cT²+dT+e (equation 4), a, b, c, d, and e are constants obtained from the test impedance values, T is the cell operating temperature, C_{F} is a cycle factor and is based on the number of charge/discharge cycles that have been performed on the electrochemical cell for which the impedance value is being determined, and S_{F} is a SOC factor at the specific cell operating parameter. In some embodiments, the cycle factor C_{F} is based on the number of charge and discharge cycles that the electrochemical cell has been subjected to (e.g., in a range of about 500 cycles to about 15,000 cycles, inclusive), which contributes to degradation of the electrochemical cell that is generally accompanied by an increase in impedance of the electrochemical cell. In some embodiments, S_{F} includes the following equation.

$${S}_{F} = \frac{{R}_{S}}{2.36} \qquad ( 6 )$$

where,

$${R}_{S} = x {S}^{2} - y S + z , \qquad ( 7 )$$

where x, y, and z are constants obtained from the test impedance values, and 0≤S=SOC≤1. In some embodiments, x, y, and z may be obtained by inserting test impedance values at a specific at various test SOC values at a specific test temperature, and solving for x, y, and z. While equation (6) represents a single equation, in some implementations, the computation system 130 may be configured to determine multiple SOC factor equations with each equation corresponding to a particular SOC. Moreover, while equation (5) is illustrated as including only the cycle factor C_{F} and the SOC factor S_{F}, in some implementations, equation (5) may additionally, or alternatively, include other factors to account for the effect of other operating parameters on the impedance of the electrochemical cell. Such factors may include, but are not limited to factors corresponding to a dimension, a pressure, a chemical composition, a porosity, an ion speed, a degradation level, a cell end of life, a joule heating, or a reactive heating of the electrochemical cell.

In some embodiments, the computation system 130 may be configured to generate an impedance function signal indicative of the impedance function (e.g., a single impedance function or a set of impedance functions, as described herein). In some embodiments, the impedance function signal may be communicated to an external system, for example, a FEA system or simulation system that may be configured to use the impedance function(s) to estimate impedance values of a modeled electrochemical set based on cell operating parameters of the modeled electrochemical cell (e.g., a range of cell operating SOC, cell operating temperatures, or other operating parameters described herein), and may use the estimated impedance values to estimate heat generated by the modeled electrochemical cell based on the operating parameters.

The computation system 130 may be configured to receive a signal indicative of the cell operating parameters of an electrochemical cell (e.g., a physical or modeled electrochemical cell). The cell operating parameters may include, for example, a dimension, a temperature, a SOC, a number of charge and discharge cycles, a pressure, a chemical composition, a porosity, an ion speed, a degradation level, a cell end of life, a joule heating, or a reactive heating of the electrochemical cell and may have a ranges or values similar to the ranges and/or values described with respect to the test operating parameters obtained from the test electrochemical cells 110.

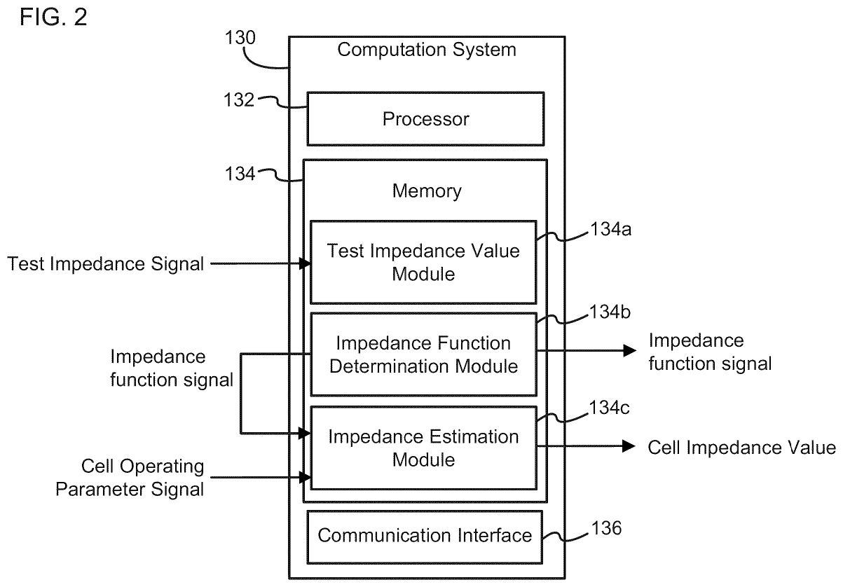

Based on the determined impedance function and the received cell operating parameters (e.g., cell operating SOC, cell operating temperature, or any other cell operating parameters described herein), the computation system 130 may be configured to estimate an impedance value of the electrochemical cell at the cell operating parameter based on the impedance function. Thus, the computation system 130 may be configured to estimate a range of impedance values of the physical or modeled electrochemical cell for a range of cell operating parameters (e.g., a range of temperatures, SOC, or other cell operating parameters, as described herein) In some embodiments, the computation system 130 may be configured to generate an impedance signal indicative of the impedance value or a range of impedance values, for example, in the form of individual values, table(s), a matrix(ces), a chart(s), any other suitable format or a combination thereof. In some embodiments, the computation system 150 may be configured to store the estimated impedance values in a memory thereof (e.g., the memory 134, as described herein with respect to FIG. 2). Thus, the computation system 130 allows estimation of impedance values of any physical or modeled electrochemical cell using the determined impedance functions for a range of cell operating parameters that the electrochemical cell is expected to be operated at or corresponding to a physical property of the electrochemical cell (e.g., cell dimensions and/or chemistry). The computation system 130 advantageously allows for reducing experimental time, resources, and cost by reducing the amount of data used for determining the impedance functions, as well as reducing computational time, computational speed, and computational power for estimating impedance values of physical or modeled electrochemical cells while increasing accuracy of the modeled heat profiles of the physical or modeled electrochemical cells.

Referring now to FIG. 2, a schematic block diagram of the computation system 130, that is included in the system 100 of FIG. 1A is shown, according to an embodiment. While FIG. 2 illustrates a particular implementation of the computation system 130, any other suitable computation system, control unit or controller configured to perform the operations described herein may be used. The computation system 130 can include a processor 132, memory 134, and a communication interface 136. The processor 132 may be implemented as a general-purpose processor, an Application Specific Integrated Circuit (ASIC), one or more. Field Programmable Gate Arrays (FPGAs), a Digital Signal Processor (DSP), a group of processing components, or other suitable electronic processing components. The memory 134 (e.g., Random Access Memory (RAM), Read-Only Memory (ROM), Non-volatile RAM (NVRAM), Flash Memory, hard disk storage, etc.) stores data (e.g., operating parameter data) and/or computer code (e.g., operating parameter filtering or processing algorithms, etc.)) for facilitating at least some of the various processes described herein. The memory 134 may include tangible, non-transient volatile memory, or non-volatile memory. The memory 134 may include a non-transitory processor readable medium having stored programming logic that, when executed by the processor 132, controls the operations of the computation system 130. In some arrangements, the memory 134 and the processor 132 form various processing circuits described with respect to the computation system 130.

The communication interface(s) 136 can include one or more satellite, WI-FI®, BLUETOOTH®, or cellular antenna. In some embodiments, the communication interface(s) 136 can be communicably coupled to an external device (e.g., an external processor) that includes one or more satellite, WI-FI, BLUETOOTH®, or cellular antenna, or a power source such as a battery or a solar panel. In some embodiments, the communication interface(s) 136 can be configured to receive a test impedance signal(s) indicative of test impedance values at a range of test operating parameters and/or a cell operating parameter signal(s) indicative of a cell operating parameter(s) for which the impedance value of an electrochemical cell is to be determined, as previously described. In some embodiments, the communication interface(s) 136 may also be configured to communicate signals to an external device (e.g., a FEA simulation system, or a local or remote database), for example, for storing the estimated impedance values and/or determining other parameters of the electrochemical cell such as heat generated in the electrochemical cell or portion thereof.

in some embodiments, the computation system 130 may include various modules implemented in hardware or software configured to perform the operations of the computation system 130. For example, as shown in FIG. 2, the computation system 130 includes a test impedance value module 134a, an impedance function determination module 134b, and an impedance estimation module 134c. It should be appreciated that these modules are for illustrative purposes only and the computation system 130 may include any other module, circuitries, sub systems, etc. to facilitate the computation system 130 in performing the operations thereof.

In one configuration, the test impedance value module 134a, the impedance function determination module 134b, and the impedance estimation module 134c can be embodied as machine or computer-readable media (e.g., stored in the memory 134) that is executable by a processor, such as the processor 132. As described herein and amongst other uses, the machine-readable media (e.g., the memory 134) facilitates performance of certain operations the test impedance value module 134a, the impedance function determination module 134b, and the impedance estimation module 134c to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). Thus, the computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, wireless network, etc.).

In another configuration, the test impedance value module 134a, the impedance function determination module 134b, and the impedance estimation module 134c may include circuitry components including, but not limited to, processing circuitry, network interfaces, peripheral devices, input devices, output devices, sensors, etc.

In some embodiments, the test impedance value module 134a, the impedance function determination module 134b, and the impedance estimation module 134c may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the test impedance value module 134a, the impedance function determination module 134b, and the impedance estimation module 134c may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on.

Thus, the test impedance value module 134a, the impedance function determination module 134b, and the impedance estimation module 134c may also include programmable hardware devices such as field programmable gate arrays, programmable array logic, programmable logic devices or the like. In this regard, the test impedance value module 134a, the impedance function determination module 134b, and the impedance estimation module 134c may include one or more memory devices for storing instructions that are executable by the processor(s) of the test impedance value module 134a, the impedance function determination module 134b, and the impedance estimation module 134c. The one or more memory devices and processor(s) may have the same definition as provided below with respect to the memory 134 and the processor 132.

In the example shown, the control unit 130 includes the processor 132 and the memory 134. The processor 132 and the memory 134 may be structured or configured to execute or implement the instructions, commands, and/or control processes described herein with respect to the test impedance value module 134a, the impedance function determination module 134b, and the impedance estimation module 134c Thus, the depicted configuration represents the aforementioned arrangement in which the test impedance value module 134a, the impedance function determination module 134b, and the impedance estimation module 134c are embodied as machine or computer-readable media. However, as mentioned above, this illustration is not meant to be limiting as the present disclosure contemplates other embodiments such as the aforementioned embodiment in which the test impedance value module 134a, the impedance function determination module 134b, and the impedance estimation module 134c, or at least one circuit thereof, are configured as a hardware unit. All such combinations and variations are intended to fall within the scope of the present disclosure. In some embodiments, the one or more processors may be shared by multiple circuits (e.g., the test impedance value module 134a, the impedance function determination module 134b, and the impedance estimation module 134c) may comprise or otherwise share the same processor which, in some example embodiments, may execute instructions stored, or otherwise accessed, via different areas of memory 134.

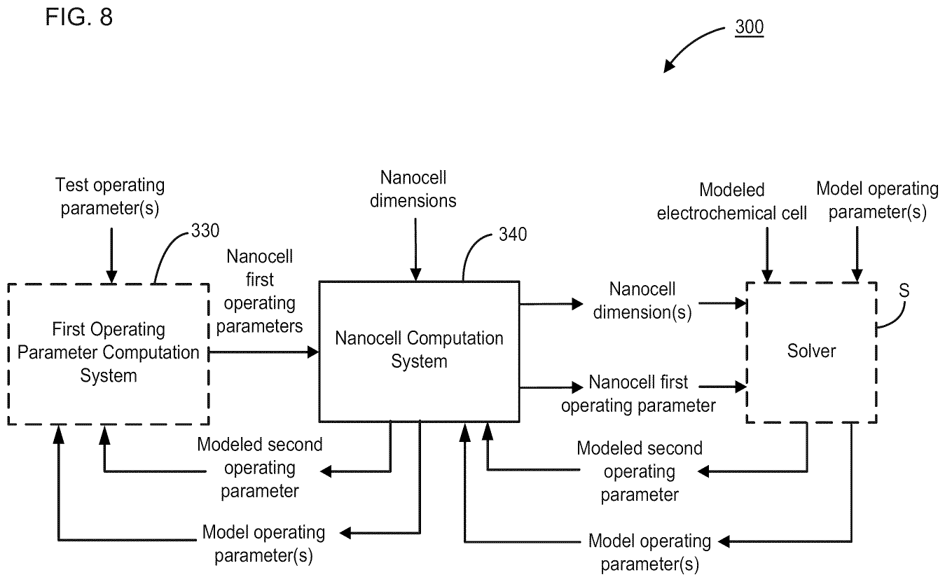

The test impedance value module 134a may be configured to receive test impedance signals from the database 120, a user or any other source and determine the test impedance values therefrom over the range of test operating parameters, as previously described herein. The impedance function determination module 134b may be configured to determine the test impedance function using the test impedance values over the range of test operating parameters, as previously described herein. In some embodiments, the impedance function determination module 134b may also be configured to generate an impedance function signal indicative of the determined impedance function, which may be communicated to an external system (e.g., the nanocell computation system 340 described with respect to FIG. 8). The impedance estimation module 134c may be configured to receive the impedance function signal from the impedance function determination module 134b, and a cell operating parameter signal indicative of cell operating parameters of an electrochemical cell the impedance values of which are intended to be determined, and estimate a cell impedance value(s) of the electrochemical cell, as previously described. The impedance estimation module 134c may also be configured to generate a cell impedance value signal indicative of the estimated cell impedance value(s), that may be communicated to an external system (e.g., the nanocell computation system 340), as previously described.

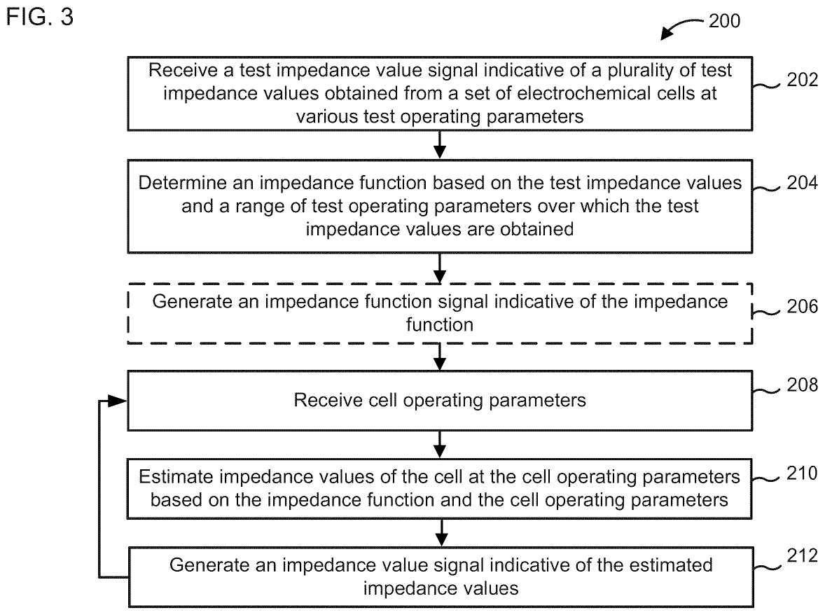

FIG. 3 shows a schematic flow chart of a method 200 for determining an impedance function and estimating impedance values of an electrochemical cell at various cell operating parameters based on the impedance function, according to an embodiment. While described with respect to the computation system 130, the test electrochemical cells 110, and the database 120, the operations of the method 200 can be performed with any computation system or controller capable of performing the operations of the method 200 using a range of test impedance values obtained from any test electrochemical cell(s). All such implementations are envisioned and should be considered to be included within the scope of the present application.

In some embodiments, the method 200 may include receiving a test impedance value signal, by the computation system 200, which is indicative of a plurality of test impedance values obtained from the set of electrochemical cells 110 at various test operating parameters, at 202, as previously described herein. For example, the computation system 130 may receive the test impedance value signal or data from the database 120, from the user, or from any other source or repository of the test impedance values.

At 204, the computation system 130 determines an impedance function based on the test impedance values and a range of test operating parameters (e.g., temperature, SOC, and/or any test operating parameters described herein). The impedance function may include any of the impedance functions described herein, for example, the cubic polynomial function represented by equation (1), the fourth order polynomial function represented by equation (4), the impedance function represented by equation (5), and/or any other impedance functions described herein, and/or or any suitable combination thereof. In some embodiments, the impedance function may include a set of impedance functions (e.g., tens, hundreds, thousands, tens of thousands, or even millions of impedance functions), as previously described herein.

In some embodiments, the method 200 may include generating an impedance function signal, by the computation system 130, which is indicative of the impedance function, at 206, as previously described herein. At 208, the computation system 200 may estimate impedance values of an electrochemical cell based on the impedance function and cell operating parameters (e.g., an impedance function of a set of impedance functions selected based on one or more cell operating parameters such as SOC and/or temperature, and estimating the cell impedance value at a desired cell operating temperature). For example, a user or an external system (e.g., the nanocell computations system 340) may enter the cell operating parameter at which a test impedance value of a physical or modeled cell is required into the computation system 130, and the computation system 130 may estimate the impedance values at the cell operating parameter using the determined impedance function (e.g., a selected impedance function from a set or plurality of determined impedance functions). At 212, the computation system 200 may generate an impedance value signal indicative of the estimated impedance values.

FIG. 8 is a schematic illustration of a system 300 for generating a nanocell, causing a modeled electrochemical cell modeled in a solver S (also referred to herein as “simulation system S”) to be divided into a plurality of nanocells, providing a first operating parameter of each of the nanocell to the simulation system S, and interrupting the simulation system S to provide an updated first parameter to the simulation system after a predetermined number of solving iterations, according to an embodiment.

Expanding further, the system 300 includes a nanocell computation system 340 (also referred to herein as “computation system 330”) that may be communicatively coupled to, or may include a first operating parameter computation system 330 (e.g., the computation system 130). The computation system 330 is communicatively coupled to the simulation system S. The simulation system S may include any known FEA simulation system such as, for example, ANSYS®, COMSOL®, FUSION 360®, MArLAB®, ADINA®, NASTRAN®, any other suitable simulation system, or any suitable combination thereof. The simulation system S is configured to receive a model of an electrochemical cell(s), stack(s), and/or assembly(ies) (e.g., a modeled electrochemical cell modeled in an external computer aided designing application) or allow drafting or developing of a 2 dimensional (2D) and/or 3 dimensional (3D) model of the cell(s), stack(s), and/or assembly(ies) therein. The modeled electrochemical cell may include any electrochemical described with respect to the electrochemical cell 110, and the model developed or communicated to the simulation system S may include a single electrochemical cell, a plurality of electrochemical cells that may be arranged in a stack or any other suitable configuration, or an assembly that includes electrochemical cell(s), electrochemical cell stack(s), and additional components including, but not limited to housing(s), fixtures, insulation or shield materials, electronics, etc.

In some embodiments, the modeled electrochemical cell may include a large electrochemical cell. In some embodiments, the large electrochemical cell may have a dimension of at least about 100 mm×about 100 mm. In some embodiments, at least one dimension of the large electrochemical cell (e.g., a length, width, and/or height) may be at least about 100 mm in some embodiments, at least one dimension of the large electrochemical cell may be at least about 200 mm. In some embodiments, at least one dimension of the large electrochemical cell may be at least about 300 mm. In some embodiments, at least one dimension of the large electrochemical cell may be at least about 400 mm. In some embodiments, at least one dimension of the large electrochemical cell may be at least about 500 mm. In some embodiments, at least one dimension of the large electrochemical cell may be at least about 600 mm. In some embodiments, at least one dimension of the large electrochemical cell may be at least about 700 mm. In some embodiments, at least one dimension of the large electrochemical cell may be at least about 800 mm. In some embodiments, at least one dimension of the large electrochemical cell may be at least about 900 mm. In some embodiments, at least one dimension of the large electrochemical cell may be at least about 1,000 mm. In some embodiments, at least one dimension of the large electrochemical cell may be at least about 1,200 mm. In some embodiments, at least one dimension of the large electrochemical cell may be at least about 1,400 mm. In some embodiments, at least one dimension of the large electrochemical cell may be at least about 1,600 mm. In some embodiments, at least one dimension of the large electrochemical cell may be at least about 1,800 mm. In some embodiments, at least one dimension of the large electrochemical cell may be at least about 2,000 mm.

In some embodiments, at least one dimension of the large electrochemical cell may be most about 2,000 mm. In some embodiments, at least one dimension of the large electrochemical cell may be at least about 1,800 mm. In some embodiments, at least one dimension of the large electrochemical cell may be at least about 1,600 mm. In some embodiments, at least one dimension of the large electrochemical cell may be at least about 1,400 mm. In some embodiments, at least one dimension of the large electrochemical cell may be at least about 1,200 mm. In some embodiments, at least one dimension of the large electrochemical cell may be at least about 1,000 mm.

In some embodiments, the large electrochemical cell has a length in a range of about 100 mm to about 2,000 mm, inclusive, and a width in a range of about 100 mm to about 2,000 mm, inclusive. In some embodiments, the large electrochemical cell has a length in a range of about 200 mm to about 1,900 mm, inclusive and a width in a range of about 200 mm to about 1,900 mm, inclusive. In some embodiments, the large electrochemical cell has a length in a range of about 300 mm to about 1,700 mm, inclusive, and a width in a range of about 300 mm to about 1,700 mm, inclusive. In some embodiments, the large electrochemical cell has a length in a range of about 400 mm to about 1,600 mm, inclusive, and a width in a range of about 400 mm to about 1,600 mm, inclusive. In some embodiments, the large electrochemical cell has a length in a range of about 500 mm to about 1,500 mm, inclusive, and a width in a range of about 500 mm to about 1,500 mm, inclusive. In some embodiments, the large electrochemical cell has a length of about 800 mm to about 1,200 mm, inclusive, and a width in a range of about 300 mm to about 700 mm, inclusive. In some embodiments, the large electrochemical cell has a length of about 1,000 mm and a width of about 500 mm. In some embodiments, the large electrochemical cell has a length that is larger than its width, or vice versa. In some embodiments, the large electrochemical cell is symmetric, i.e., has a length that is about the same as its width.

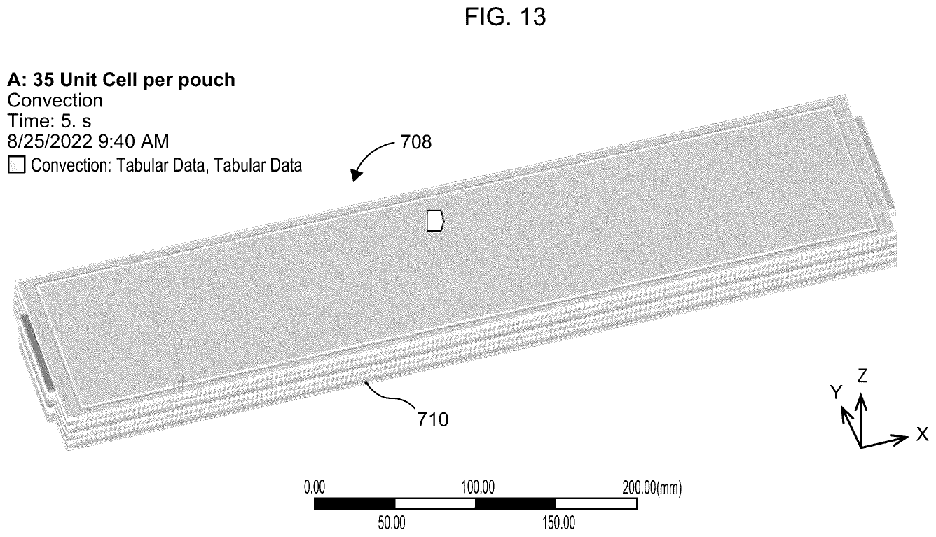

The large electrochemical cell may include any suitable combination of length width or height, as described herein. For example, FIG. 13 is a perspective view of a cell stack 708 including 35 large modeled electrochemical cells 710 stacked on top of each other, modeled in a simulation system. Each electrochemical cell 710 has a length of about 1,000 mm, a width of about 150 mm, and a height of less than about 1 mm such that the stack 708 has a height of less than about 50 mm. In some embodiments, model operating parameters may be entered into the simulation system S related to the modeled electrochemical cell(s) (e.g., the modeled electrochemical cell 710) stack(s) (e.g., stack 710), or assembly(ies). Such model operating parameters may include, but are not limited to a temperature, a SOC, a number of charge and discharge cycles, a pressure, a chemical composition, a porosity, an ion speed, a degradation level, a cell end of life, a joule heating, or a reactive heating of each electrochemical cell, stack, or assembly.

As previously described, conventional simulation systems such as the simulation system S are generally configured such that they use input model operating parameters as being unform across the entire modeled electrochemical cell. However, as electrochemical cells and particularly large electrochemical cells operate, there can be substantial variations in operating parameters of the cell (e.g., impedance and thereby, temperature and heat generation, fluid flow across cell, chemical composition, state of charge, etc.) over the length, width, and or thickness of the electrochemical cell(s), stack(s), or assembly(ies) over a period of time. Conventional simulation systems may not be able to account for these variations leading to inaccuracies in FEA analysis of the modeled electrochemical cell.

To improve the accuracy of the simulation system, the system 300 includes the nanocell computation system 340 that is configured to divide the modeled electrochemical cell into a plurality of nanocells having known dimensions, and update operating parameters of each of the plurality of nanocells after one or more iterative solving cycles or steps, or sub-cycles or sub-steps of the simulation system S to allow more accurate estimation of operating parameters of each nanocell and thereby, the modeled electrochemical cell, stack(s), or assembly(ies) that are being estimated by the simulation system S. Expanding further, the nanocell computation system 340 is a non-linear dynamic computation system that is communicatively coupled to the simulation system S. In some embodiments, the nanocell computation system 340 is configured to receive a dimension signal indicative of a dimension of a nanocell. For example, a user may input a dimension (e.g., a length, width, and/or height) of the nanocell into the computation system 340.

The nanocell(s) generated by the nanocell computation system 340 may have any suitable shape, for example, at least one of a square, rectangular, triangular, polygonal, or asymmetric shape having a predetermined height. In some embodiments, each of the nanocell(s) generated by the nanocell computation system 340 has the same dimensions (e.g., same size and shape). In some embodiments, the plurality of nanocells may have a cube shape. For example, in some embodiments, the nanocell may have a dimension in a range of about 1 micron×1 micron×1 micron to about 50 mm×50 mm×50 mm, inclusive. In some embodiments, the nanocell may have a dimension in a range of about 5 microns×5 microns×5 microns to about 40 mm×40 mm×40 mm, inclusive. In some embodiments, the nanocell may have a dimension in a range of about 10 microns×10 microns×10 microns to about 30 mm×30 mm×30 mm, inclusive. In some embodiments, the nanocell may have a dimension in a range of about 50 microns×50 microns×50 microns to about 20 mm×20 mm×20 mm, inclusive. In some embodiments, the nanocell may have a dimension in a range of about 100 microns×100 microns×100 microns to about 10 mm×10 mm×10 mm, inclusive. In some embodiments, the nanocell may have a dimension in a range of about 200 microns×200 microns×200 microns to about 1 mm×1 mm×1 mm, inclusive.

In some embodiments, the nanocell has a dimension of at least about 1 micron×1 micron×1 micron. In some embodiments, the nanocell has a dimension of at least about 5 microns×5 microns×5 microns. In some embodiments, the nanocell has a dimension of at least about 10 microns×10 microns×10 microns. In some embodiments, the nanocell has a dimension of at least about 20 microns×20 microns×20 microns. In some embodiments, the nanocell has a dimension of at least about 30 microns×30 microns×30 microns. In some embodiments, the nanocell has a dimension of at least about 40 microns×40 microns×40 microns. In some embodiments, the nanocell has a dimension of at least about 50 microns×50 microns×50 microns. In some embodiments, the nanocell has a dimension of at least about 100 microns×100 microns×100 microns. In some embodiments, the nanocell has a dimension of at least about 200 microns×200 microns×200 microns. In some embodiments, the nanocell has a dimension of at least about 300 microns×300 microns×300 microns. In some embodiments, the nanocell has a dimension of at least about 400 microns×400 microns×400 microns. In some embodiments, the nanocell has a dimension of at least about 500 microns×500 microns×500 microns. In some embodiments, the nanocell has a dimension of at least about 1 mm×1 mm×1 mm. In some embodiments, the nanocell has a dimension of at least about 5 mm×5 mm×5 mm. In some embodiments, the nanocell has a dimension of at least about 10 mm×10 mm×10 mm.

In some embodiments, the nanocell has a dimension of at most about 50 mm×50 mmn×50 mm. In some embodiments, the nanocell has a dimension of at least about 40 mm×40 mm×40 mm. In some embodiments, the nanocell has a dimension of at least about 30 mm×30 mm×30 mm. In some embodiments, the nanocell has a dimension of at least about 20 mm×20 mm×20 mm. In some embodiments, the nanocell has a dimension of at least about 10 mm×10 mm×10 mm. In some embodiments, the nanocell has a dimension of at least about 1 mm×1 mm×1 mm. In some embodiments, the nanocell has a dimension of at least about 500 microns×500 microns×500 microns. In some embodiments, the nanocell has a dimension of at least about 400 microns×400 microns×400 microns. In some embodiments, the nanocell has a dimension of at least about 300 microns×300 microns×300 microns. In some embodiments, the nanocell has a dimension of at least about 200 microns×200 microns×200 microns. In some embodiments, the nanocell has a dimension of at least about 100 microns×100 microns×100 microns. In some embodiments, a length, and width, and a height of the nanocell may be equal to each other. In some embodiments, the length and/or width of the nanocell may be greater than a height of the nanocell.

In some embodiments, a volume of the nanocell may be in a range of about 1 cubic micron to about 125 cubic centimeter, inclusive. In some embodiments, a volume of the nanocell may be in a range of about 10 cubic micron to about 10 cubic centimeter, inclusive. In some embodiments, a volume of the nanocell may be in a range of about 10 cubic micron to about 1 cubic centimeter, inclusive. In some embodiments, a volume of the nanocell may be in a range of about 100 cubic micron to about 0.1 cubic centimeter, inclusive. In some embodiments, a volume of the nanocell may be in a range of about 500 cubic micron to about 0.0001 cubic centimeter, inclusive. In some embodiments, a volume of the nanocell may be in a range of about 1,000 cubic micron to about 100,000 cubic micron, inclusive. In some embodiments, a volume of the nanocell may be in a range of about 10,000 cubic micron to about 50,000 cubic micron, inclusive.

In some embodiments, a volume of the nanocell may be in a range of about 10 cubic micron to about 45,000 cubic micron, inclusive. In some embodiments, a volume of the nanocell may be in a range of about 50 cubic micron to about 40,000 cubic micron, inclusive. In some embodiments, a volume of the nanocell may be in a range of about 100 cubic micron to about 35,000 cubic micron, inclusive. In some embodiments, a volume of the nanocell may be in a range of about 500 cubic micron to about 30,000 cubic micron, inclusive. In some embodiments, a volume of the nanocell may be in a range of about 1,000 cubic micron to about 20,000 cubic micron, inclusive. In some embodiments, a volume of the nanocell may be in a range of about 2,000 cubic micron to about 10,000 cubic micron, inclusive.

In some embodiments, a volume of the nanocell is at least about 1 cubic micron. In some embodiments, a volume of the nanocell is at least about 5 cubic micron in some embodiments, a volume of the nanocell is at least about 10 cubic micron. In some embodiments, a volume of the nanocell is at least about 50 cubic micron. In some embodiments, a volume of the nanocell is at least about 100 cubic micron. In some embodiments, a volume of the nanocell is at least about 500 cubic micron. In some embodiments, a volume of the nanocell is at least about 1,000 cubic micron. In some embodiments, a volume of the nanocell is at least about 5,000 cubic micron. In some embodiments, a volume of the nanocell is at least about 10,000 cubic micron. In some embodiments, a volume of the nanocell is at least about 50,000 cubic micron. In some embodiments, a volume of the nanocell is at least about 100,000 cubic micron. In some embodiments, a volume of the nanocell is at least about 1,000,000 cubic micron. In some embodiments, a volume of the nanocell is at least about 10,000,000 cubic micron. In some embodiments, a volume of the nanocell is at least about 0.0001 cubic centimeter. In some embodiments, a volume of the nanocell is at least about 0.001 cubic centimeter. In some embodiments, a volume of the nanocell is at least about 0.01 cubic centimeter. In some embodiments, a volume of the nanocell is at least about 0.1 cubic centimeter. In some embodiments, a volume of the nanocell is at least about 1 cubic centimeter. In some embodiments, a volume of the nanocell is at least about 10 cubic centimeter. In some embodiments, a volume of the nanocell is at least about 100 cubic centimeter.

In some embodiments, a volume of the nanocell is at most about 125 cubic centimeter. In some embodiments, a volume of the nanocell is at most about 100 cubic centimeter. In some embodiments, a volume of the nanocell is at most about 10 cubic centimeter. In some embodiments, a volume of the nanocell is at most about 1 cubic centimeter. In some embodiments, a volume of the nanocell is at most about 0.1 cubic centimeter. In some embodiments, a volume of the nanocell is at most about 0.01 cubic centimeter. In some embodiments, a volume of the nanocell is at most about 0.001 cubic centimeter. In some embodiments, a volume of the nanocell is at most about 0.0001 cubic centimeter. In some embodiments, a volume of the nanocell is at most about 10,000,000 cubic micron. In some embodiments, a volume of the nanocell is at most about 1,000,000 cubic micron. In some embodiments, a volume of the nanocell is at most about 100,000 cubic micron. In some embodiments, a volume of the nanocell is at most about 50,000 cubic micron. In some embodiments, a volume of the nanocell is at most about 40,000 cubic micron. In some embodiments, a volume of the nanocell is at most about 30,000 cubic micron. In some embodiments, a volume of the nanocell is at most about 20,000 cubic micron. In some embodiments, a volume of the nanocell is at most about 10,000 cubic micron. In some embodiments, a volume of the nanocell is at most about 1,000 cubic micron. In some embodiments, a volume of the nanocell is at most about 500 cubic micron. In some embodiments, a volume of the nanocell is at most about 100 cubic micron. Combinations of the various dimensions and/or volumes of the nanocells described herein are contemplated, and all such variations or values should be considered to be within the scope of the present disclosure.

The nanocell computation system 340 is configured to communicate a nanocell signal to the simulation system S, the nanocell signal configured to divide the modeled electrochemical cell modeled in the simulation system S into a plurality of nanocells based on the received dimension of the nanocell. In other words, the nanocell signal causes a plurality of nanocells generated by the nanocell computation system 340 to be mapped onto the modeled electrochemical cell such that the mapped nanocells are stacked side by side and/or on top of each other to map the entire volume of the modeled electrochemical cell (or otherwise cell stack, or assembly).

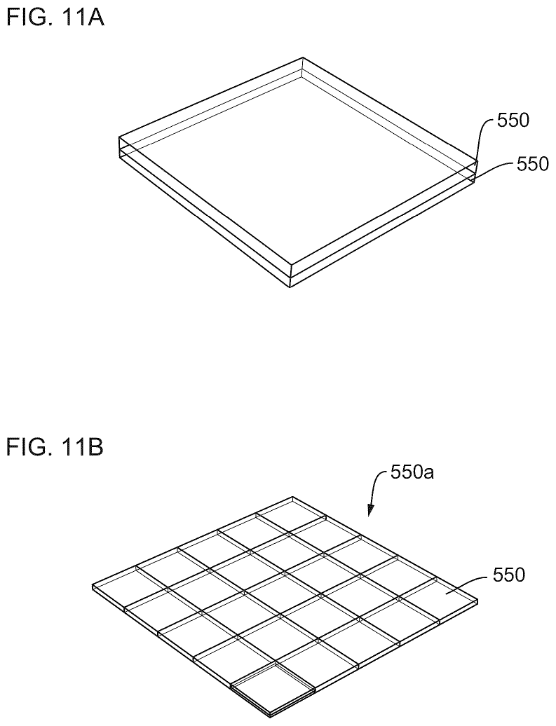

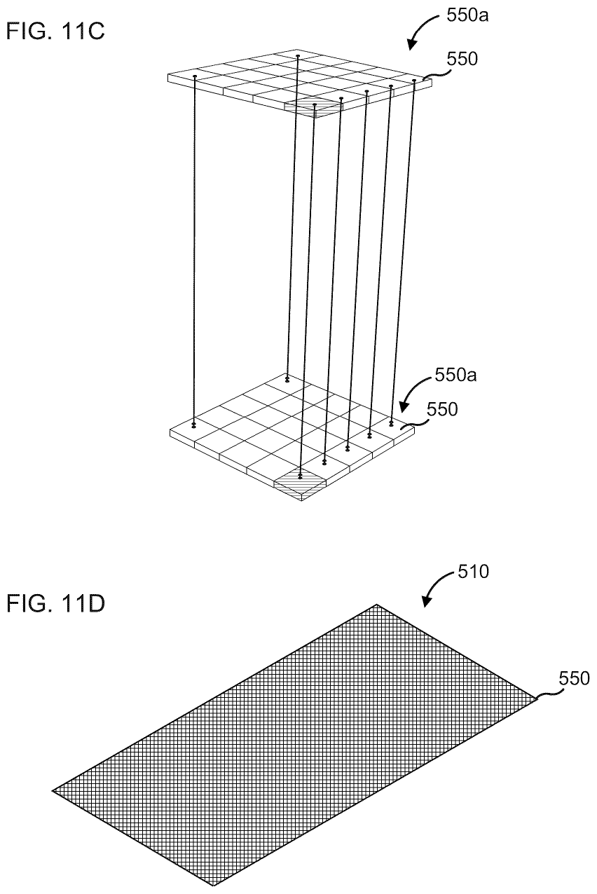

For example, FIG. 11A shows an example a pair of example nanocells 550 having a cube or prismatic shape, which are generated by the nanocell computation system 340. Each of the nanocells 550 may have varying 3D non-linear operating parameters (e.g., a temperature, a SOC, a number of charge and discharge cycles, a pressure, a chemical composition, a porosity, an ion speed, a degradation level, a cell end of life, a joule heating, a reactive heating, etc.), and the nanocell computation system 340 may be configured to adjust or vary the operating parameters of each of the nanocell individually and independently, as described herein.

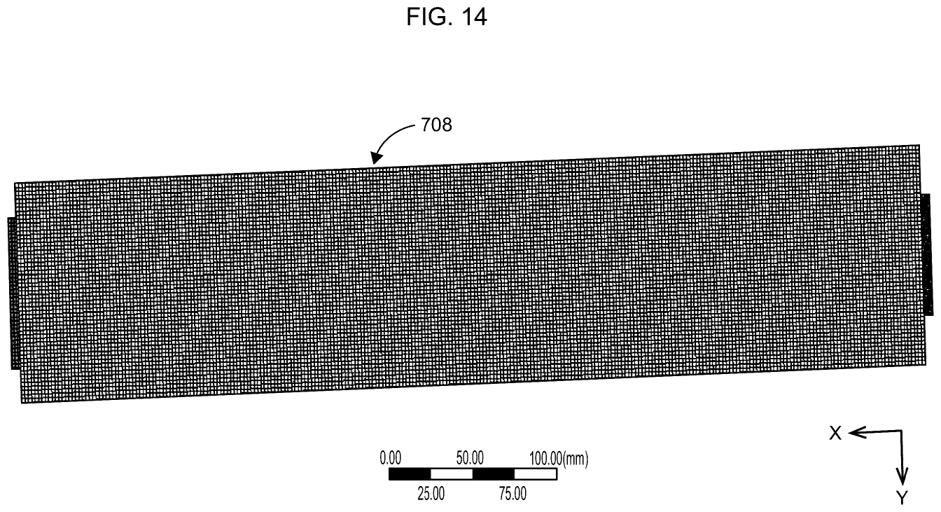

The nanocell signal is configured to map the nanocells with each of the nanocell having the same dimension, over the entire volume of the electrochemical cell such that the modeled electrochemical cell is divided into the plurality of nanocells. For example, FIG. 111B shows a plurality of nanocells 550 arranged in a square array 550a. FIG. 11C shows two example square arrays 550a of the plurality of nanocells 550 being stacked on top of each other. In this manner, a plurality of nanocells 550 or any other nanocells described can be stacked side by side and/or on top of each other in any suitable configuration to map to a modeled electrochemical cell(s), stack(s), or assembly(ies) having any suitable shape or size. For example, FIG. 11D shows an example modeled electrochemical cell 510 modeled in a simulation system and divided into a plurality of nanocells by mapping a plurality of nanocells 550 onto the modeled electrochemical cell 510 until the entire volume of the modeled electrochemical cell 510 is divided into the plurality of nanocells 550. Similarly, FIG. 14 is a top view of the electrochemical cell stack 708 being divided into a plurality of nanocells based on a signal received from the computation system 340.

Each of the nanocell that the modeled electrochemical cell(s), stacks(s), or assembly(ies) is divided into based on the nanocell signal received from the nanocell computation system 340 is an independent unit whose operating parameters (e.g., impedance, or any of the other parameters described herein) can be independently varied or adjusted by the nanocell computation system 340. Thus, instead of the simulation system S applying the same values of one or more operating parameters over the entire area and volume of the cell(s), stacks(s), or assembly(ies) over various iterative cycles (i.e., each iterative solution step), the computation system 340 allows values of the operating parameters to be changed at each nanocell level. In this manner, the nanocell computation system 340 allows granular control over the operating parameters of the cell(s), stack(s), or assembly(ies) substantially increasing accuracy, and reducing computing power as well as computation time.

To run simulated tests on modeled electrochemical cell(s), stack(s), or assembly(ies), the simulation system S or any other simulation system described herein divides or meshes the modeled electrochemical cell into finite element units and runs iterative solving cycles on the meshed model to determine the simulated parameters of the cell(s), stack(s), or assembly(ies) based on input model operating parameters. The nanocell computation system 340 is configured to map and thereby, divide the modeled electrochemical cell into the plurality of nanocells such that each nanocell is mapped to at least one finite element unit generated by the simulation system S. In other words, the nanocell computation system 340 is configured to map the plurality of nanocells to the modeled electrochemical cell(s), stack(s), or assembly(ies) modeled in the simulation system S and meshed into a plurality of finite element units by the simulation system S such that each finite element unit is geometrically contained within a nanocell, or each finite element unit contains at least one nanocell, multiple nanocells, or a fraction of at least one nanocell.

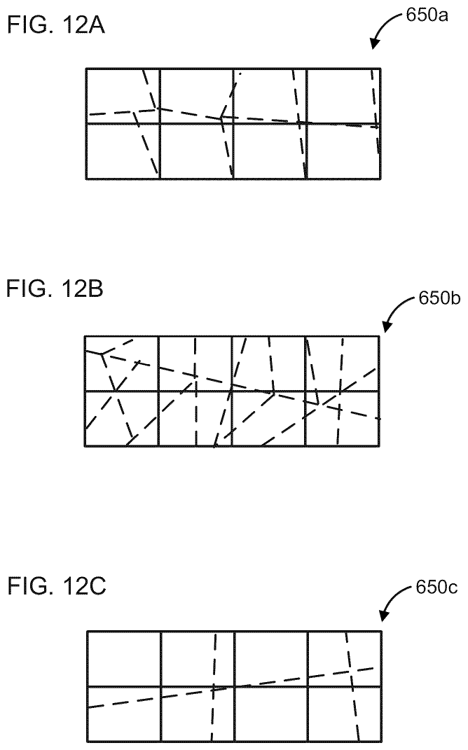

For example, FIG. 12A is a schematic illustration of a portion of a modeled electrochemical cell 650a modeled in the simulation system S, with the simulation system S dividing the modeled electrochemical cell 650a into a plurality of finite element units (dotted lines) and the nanocell computation system 340 of FIG. 8 dividing the electrochemical cell into a plurality of nanocells (solid lines) In this implementation, each nanocell has a dimension (e.g., area or volume) that is substantially similar (e.g., within +/−10%) of a corresponding dimension of a corresponding finite element unit. This allows each nanocell to be mapped to a single finite element unit. In some embodiments, if one finite element unit overlaps or maps onto two or more finite element units, the nanocell computation system 340 may be configured to instruct the simulation system S to use an average operating parameter value of the overlapping nanocells for each of the finite element unit in its iterative cycles to determine the simulated operating parameter at that finite element unit.

FIG. 12B is a schematic illustration of a portion of a modeled electrochemical cell 650b modeled in the simulation system S, with the simulation system S dividing the modeled electrochemical cell 650b into a plurality of finite element units (dotted lines) and the computation system 340 of FIG. 8 dividing the electrochemical cell into a plurality of nanocells (solid lines). Different from the electrochemical cell 650a, each nanocell has a dimension that is larger than each finite element unit such that each nanocell is mapped to a plurality of finite element units. In such implementations, the nanocell computation system 340 is configured to instruct the simulation system S to use the operating parameter value of the nanocell that overlaps the plurality of finite element units for each of the finite element unit in its iterative cycles, and to use an average operating parameter value for nanocells that overlap two or more finite element units, as previously described with respect to FIG. 12A.

FIG. 12C is a schematic illustration of a portion of a modeled electrochemical cell 650c modeled in the simulation system S, with the simulation system S dividing the modeled electrochemical cell 650b into a plurality of finite element units (dotted lines) and the computation system of FIG. 8 dividing the electrochemical cell into a plurality of nanocells (solid lines). Different from the electrochemical cells 650a and 650b, each nanocell has a dimension that is larger than each finite element unit such that a plurality of nanocells are mapped to each finite element unit (i.e., each finite element unit contains more than one nanocell) In such implementations, the nanocell computation system 340 may be configured to instruct the simulation system S to use an average operating parameter value based on the first operating parameter values of each nanocell that lies within a finite element unit for use in the simulation system S's iterative cycles, and to use an average operating parameter value of overlapping nanocell for nanocells that overlap two or more finite element units, as previously described with respect to FIG. 12A.

Referring back to FIG. 8, the nanocell computation system 340 is configured to communicate a first set of first operating parameters to the simulation system S, each of the first operating parameter in the first set corresponding to a respective nanocell of the plurality of nanocells that are mapped onto modeled electrochemical cell to divide the modeled electrochemical cell (or stack(s) and/or assembly(ies)) into the plurality of nanocells. The first operating parameter can include any suitable parameter such as, for example, temperature, impedance, voltage, current, fluid flow (e.g., air flow), chemical composition (e.g., chemical composition), pressure, SOC, life cycle, any other suitable operating parameter, or any suitable combination thereof. In some embodiments, the first operating parameter includes an impedance of each nanocell of the plurality of nanocells.

In some embodiments, the nanocell computation system 340 may be configured to receive the first set of first operating parameters from a first operating parameter computation system 330, the first set of first operating parameters estimated by the first operating parameter system 330 based on test operating parameters of a set of test electrochemical cells received by the first operating parameter computation system 330. For example, the first operating parameter computation system 330 may include the computation system 130, as previously described herein, that is configured to receive test operating parameters (e.g., a dimension, a temperature, a SOC, a pressure, a chemical composition, a porosity, an ion speed, a degradation level, a cell end of life, a joule heating, a reactive heating, or a fluid flow around the set of test electrochemical cells, or any suitable combination thereof) and based on the test operating input operating parameters and input operating parameters (e.g., model operating parameters) determine the first operating parameter (e.g., the impedance of the electrochemical cell or any other first operating parameter as described in detail with respect to the system 100). In some embodiments, the first operating parameter computation system 330 may be included in (e.g., be integrated in or be a part of) the nanocell computation system 340.

The nanocell computation system 340 may be configured to communicate a solve signal to the simulation system S (e.g., after the plurality of nanocells have been mapped onto the modeled electrochemical cell and the first set of first operating parameters have been communicated to the simulation system S). The solve signal may be configured to cause the simulation system S to determine a second operating parameter of each of the plurality of nanocells based at least on the corresponding first operating parameter. For example, the simulation system S may perform iterative solving cycles, step, or sub-steps in response to the solve signal to determine the second operating parameter for each of the plurality of nanocells via FEA simulations. In some embodiments, the second operating parameter may include at least one of a temperature, a heat flux, current, voltage, a current density, any other suitable current parameter determined by the simulation system S based on the first operating parameter and any other model operating parameter(s) input into the simulation system S by a user. Such model operating parameter(s) may include, but are not limited to a charge/discharge rate (C-rate), initial cell temperature, ambient temperature, external pressure, charge/discharge voltage, charge/discharge current, SOC, State of Health (SOH). Depth of Discharge (DOD), or any other parameter of the interest that is desired to be simulated by the simulation system S.

The nanocell computation system 340 may be configured to communicate an interrupt signal to the simulation system S, the interrupt signal configured to interrupt the simulation system S after a predetermined number of iterative solving cycles performed by the simulation system S on each of the plurality of nanocells. In some embodiments, the nanocell computation system 340 may be configured to communicate the interrupt signal to the simulation system S after a predetermined time after the simulation system S starts its iterative cycles, for example, in a range of about 1 second to about 5 minutes, inclusive (e.g., after 1 second, 2 second, 3 second, 4 second, 5 second, 10 second, 20 second, 30 second, 40 second, 50 second, 1 minute, 2 minute, 3 minute, 4 minute, or 5 minute, inclusive after the simulation system S starts its iterative solving cycles). In some embodiments, the nanocell computation system 340 may be configured to communicate the interrupt signal to the simulation system S after each iterative cycle or step (e.g., a non-linear solving cycle or step) performed by the simulation system S. In some embodiments, the nanocell computation system 340 may be configured to communicate the interrupt signal to the simulation system S after a predetermined number of iterative solving cycles, or steps, for example, in a range of 1 iterative cycle to 1,000 iterative solving cycles, inclusive (e.g., after 1, 2, 3, 4, 5, 10, 15, 20, 30, 40, 50, 60, 70, 80, 90, 100, 200, 300, 400, 500, 600, 700, 800, 900, or 1,000 iterative cycles, inclusive). In some embodiments, each iterative solution cycle may include one or more non-linear sub-steps. In some embodiments, the nanocell computation system 340 may be configured to communicate the interrupt signal to the simulation system S after each iterative solving cycle or step, with each cycle or step including a plurality of sub-cycles or sub-steps.

The interrupt signal causes the simulation system S to stop performing its solving iterations on the modeled electrochemical cell, such that second operating parameter of each of the plurality of nanocells determined by the simulation system S is based on the initial first operating parameters of each of the plurality of nanocells provided to the simulation system S by the nanocell computation system 340 during the time period the first iterative cycles were performed on the plurality of nanocells by the simulation system S.

The nanocell computation system 340 may be configured to receive a set of the second operating parameters from the simulation system S, with each of the second operating parameter in the set corresponding to a respective nanocell of the plurality of nanocells. Moreover, the nanocell computation system 340 may be configured to receive a second set of first operating parameters determined based at least on the set of second operating parameters, each of the first operating parameter in the second set corresponding to a respective nanocell of the plurality of nanocells.

For example, the nanocell computation system 340 may communicate the set of second operating parameters (e.g., temperature, heat generated, current, voltage, etc.) to the first operating parameter computation system 330. In some embodiments, the nanocell computation system 340 may also communicate the model operating parameters (e.g., state of charge, a pressure, a chemical composition, a porosity, an ion speed, a degradation level, a cell end of life, a joule heating, a reactive heating, ambient temperature, or a fluid flow etc.) of the modeled electrochemical cell and thereby, each of the plurality of nanocells to the first operating parameter computation system 330. The first operating parameter computation system 330 may be configured to determine a new first operating parameter for each of the plurality of nanocells based on the second operating parameter for the respective nanocell and communicate a second set of first operating parameters that includes the newly determined first operating parameters to the computation system 330.

The nanocell computation system 340 may also be configured to communicate the second set of first operating parameters to the simulation system S for determining an updated second operating parameter of each nanocell of the plurality of nanocells. In this manner, the nanocell computation system 340 may be configured to sequentially update the first operating parameters of each of the plurality of nanocells after predetermined iterative solving cycles, to cause the simulation system S to determine the updated set of second operating parameters after the predetermined number of iterative cycles, and continues to do so for the entire number of iterative cycles that the simulation system S is intended or desired to run for.

As previously described, there may be large variations in operating parameters of the various portions of electrochemical cells, particularly large electrochemical cells during operation thereof. For example, the temperature and thereby, heat generated by the electrochemical cells, particularly large electrochemical cells, may be substantially different towards the center of the electrochemical cell relative to the edges of the electrochemical cell, or relative to current collector tabs of the electrochemical cells. The effect may be even more pronounced in electrochemical cell assemblies where multiple electrochemical cells are stacked on top of each other, side by side, electronically coupled to each other in series and/or parallel configuration, or have other components disposed therebetween or therearound. By dividing the electrochemical cells into a plurality of nanocells, providing first operating parameter values of each of the plurality of nanocells to the simulation system S, updating the first parameter values of each nanocell based on the second operating parameter values determined by the simulation system S for the respective nanocell, providing the updated first parameter values to the simulation system S for determining updated second parameter values for each nanocell, and continuing to do so over multiple iterative solving cycles of the simulation system S substantially increases modeling accuracy, and reduces computation time and computation power used.

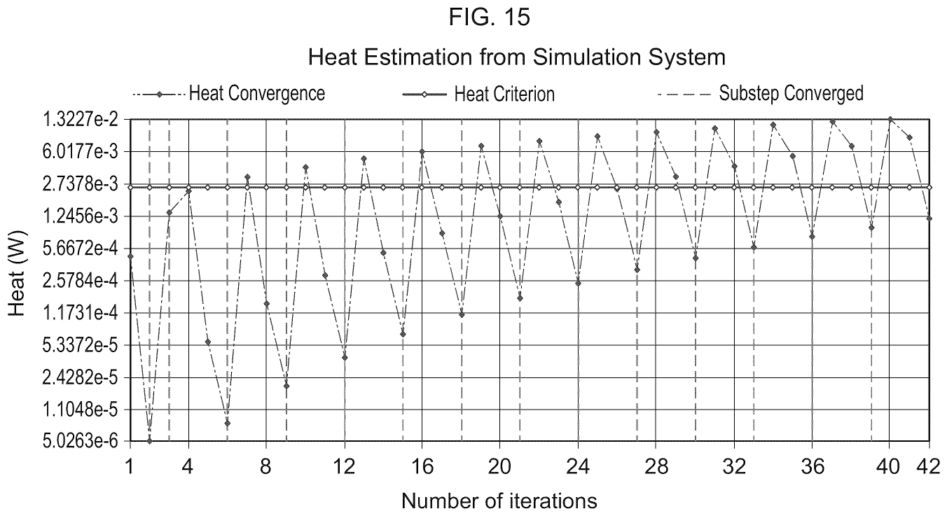

In some embodiments, the first operating parameter may include an electrochemical cell impedance, and the second parameter may include a temperature and/or heat generated by the nanocells. For example. FIG. 15 is a plot of heat generated by a nanocell of a plurality of nanocells that the modeled electrochemical cells 710 included in the electrochemical cell stack 708 of FIGS. 13-14 is divided into, estimated by the simulation system S over 42 iterations. The modeled electrochemical cell is simulated by the simulation system S to be operating at a Cl discharge rate, a current of 4.5 A, a voltage of 3.6 V, and ambient air temperature of 25 degrees Celsius. The nanocell computation system 340 interrupts the simulation system S after every 1 or 2 iterations, and transmits the temperature corresponding to the heat value to the first operating parameter computation system 330 and requests new impedance values from the computation system 330 based on the estimated temperature Once the new impedance values are received, the nanocell computation system 340 communicates the new impedance values corresponding to the respective nanocell to the simulation system S and instructs the simulation system S to determine new heat values for the nanocell, and so on and so forth. In this manner, the nanocell computation system 340 enables changing, varying, or adjusting of one or more properties of each of the nanocell at various times, temperature, life cycle, pressure, etc., thus increasing modeling accuracy.

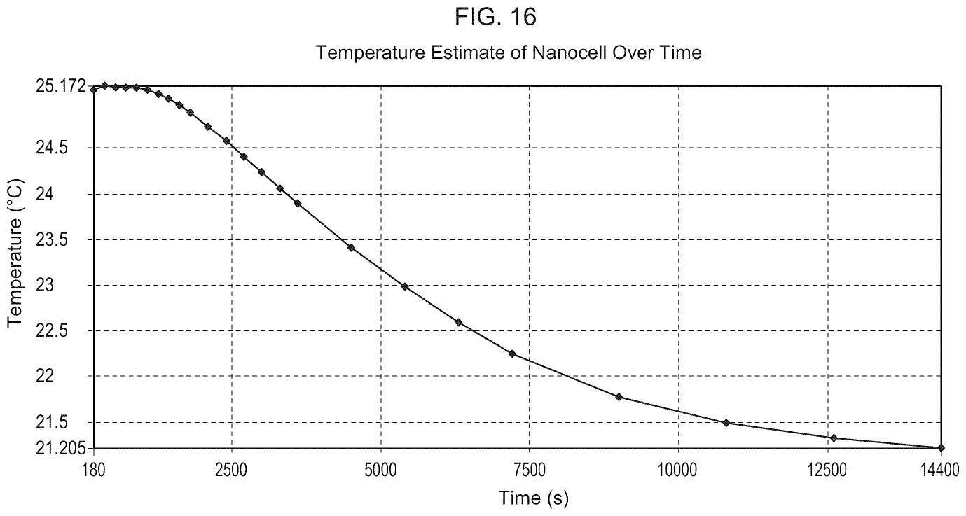

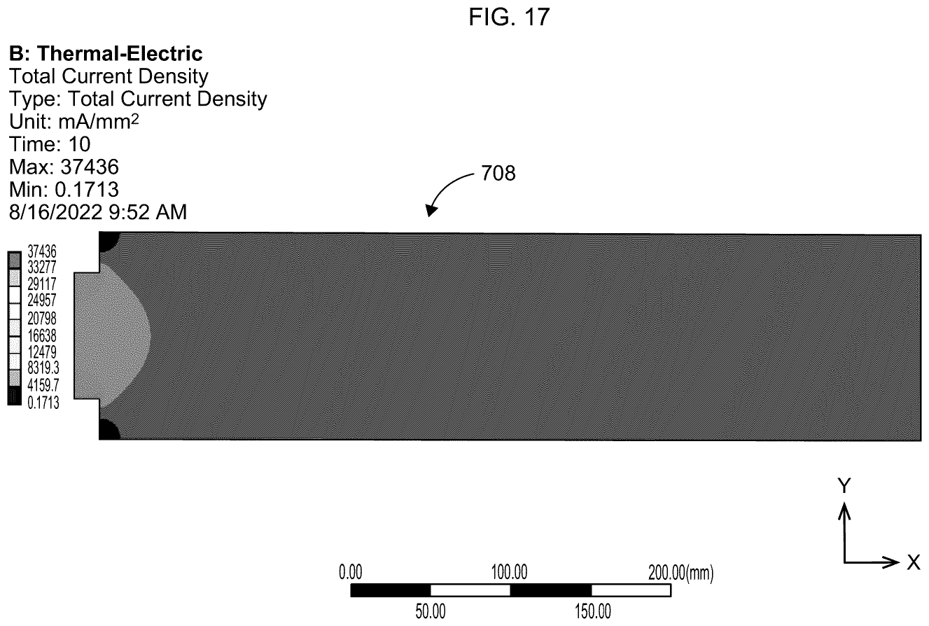

FIG. 16 is a plot of maximum temperature of the nanocell overtime determined by the simulation system S with the nanocell computation system 340 modifying the non-linear properties of the nanocell (e.g., impedance) at every SOC, life cycle, temperature, etc., of the nanocell after a predetermined number of iterative cycles. FIG. 17 is a top view of the modeled electrochemical cell stack 708 of FIG. 14 with current density across the modeled electrochemical cell stack 708 being estimated by the simulation system S based on heat generation determined by the simulation system S over various iteration cycles using impedance values for each of the plurality of nanocells provided by the computation system of FIG. 8.

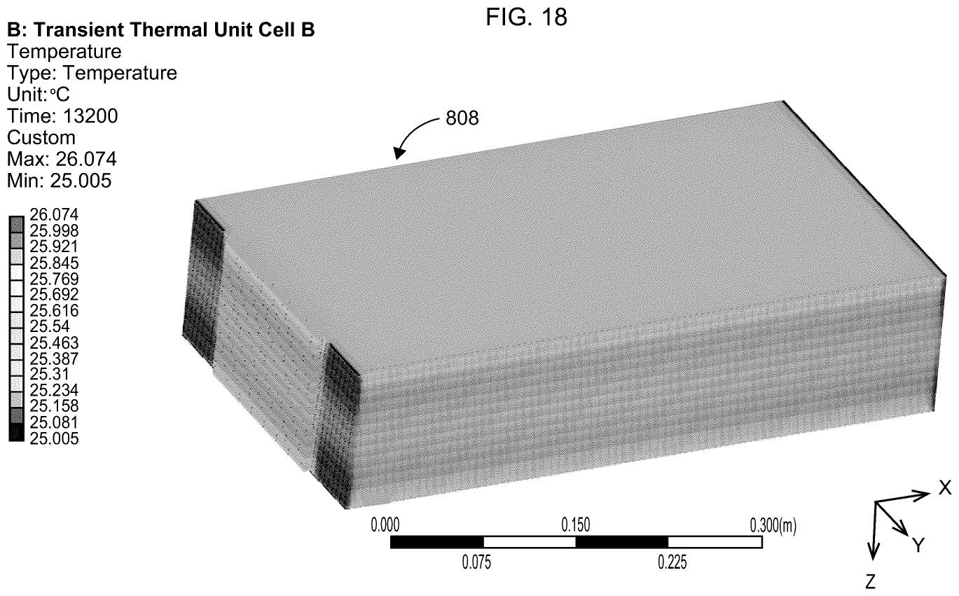

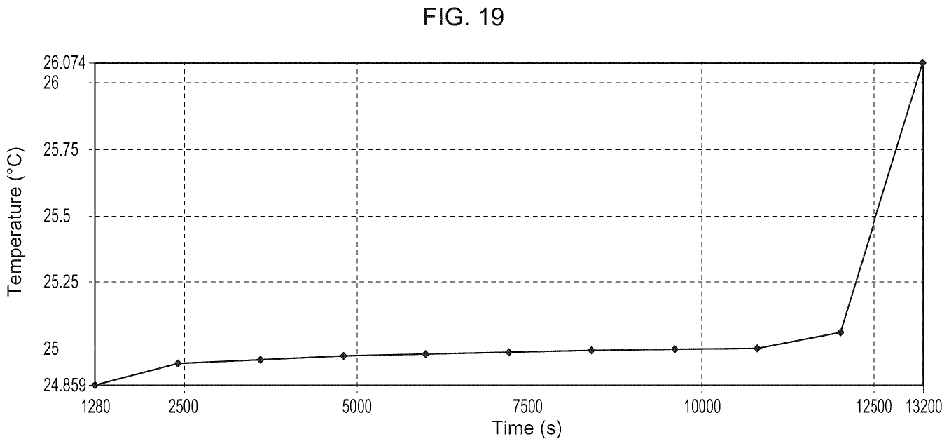

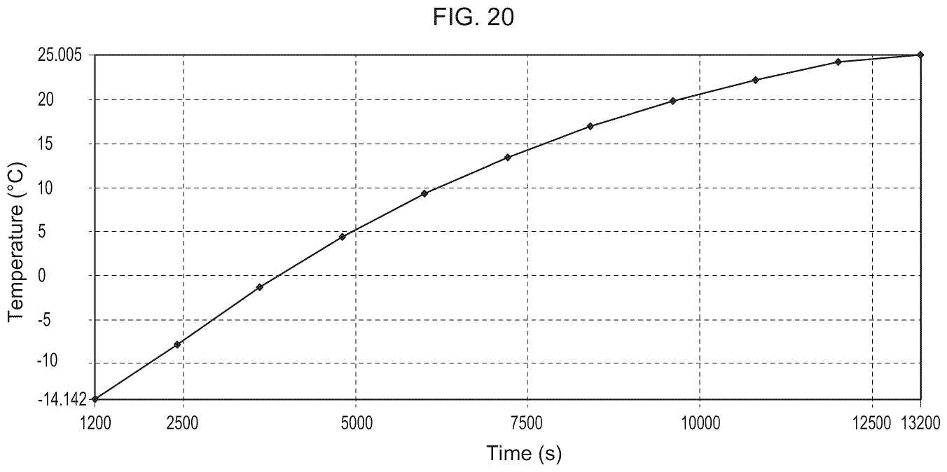

FIG. 18 is a perspective view of another thick modeled electrochemical cell stack 808 being modeled in the simulation system S, and divided into a plurality of nanocells by the computation system of FIG. 8. A temperature across the modeled electrochemical cell stack 808 is determined by the simulation system S using updated impedance values for each of the plurality of nanocells being provided to the simulation system S by the nanocell computation system 340. Initial temperature of the plurality of nanocells is −20 degree Celsius, ambient temperature is 25 degrees Celsius, and convection cooling is 20 W/m² at C4 rate. FIG. 19 is a plot of temperature of a nanocell included in the modeled electrochemical cell stack 808 of FIG. 18 having a maximum temperature among the plurality of nanocells. The temperature is determined by the simulation system S based on updated impedance values for the nanocell being provided to the simulation system S after predetermined iterative cycles by the nanocell computation system 340. FIG. 20 is a plot of temperature of a nanocell included in the modeled electrochemical cell stack 808 of FIG. 18 having a minimum temperature among the plurality of nanocells that the modeled electrochemical cell stack 808 is divided into.

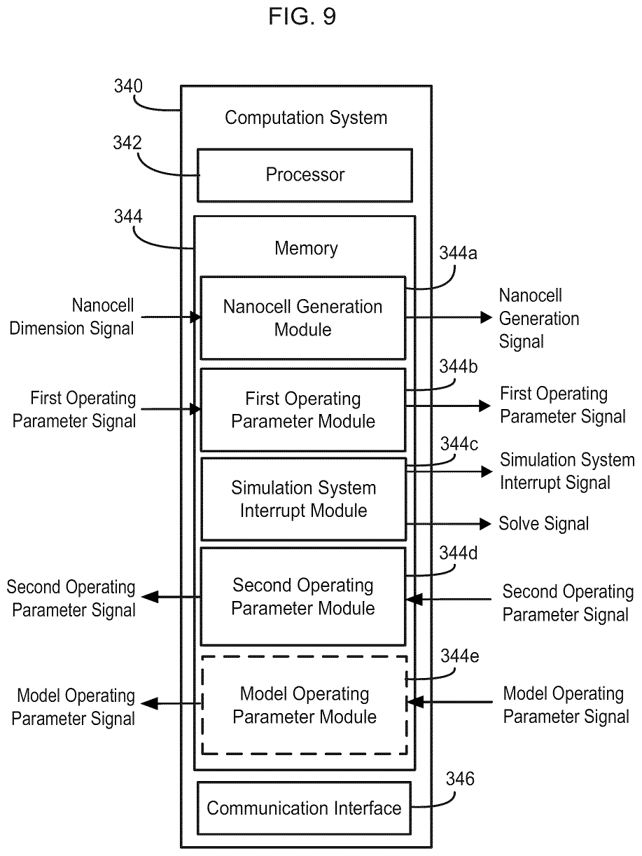

Referring now to FIG. 9, a schematic block diagram of the nanocell computation system 340, that is included in the system 300 of FIG. 8 is shown, according to an embodiment. While FIG. 9 illustrates a particular implementation of the nanocell computation system 340, any other suitable computation system, control unit or controller configured to perform the operations described herein may be used. The nanocell computation system 340 can include a processor 342, memory 344, and a communication interface 346. The processor 342 may be implemented as a general-purpose processor, an Application Specific Integrated Circuit (ASIC), one or more Field Programmable Gate Arrays (FPGAs), a Digital Signal Processor (DSP), a group of processing components, or other suitable electronic processing components. The memory 344 (e.g., Random Access Memory (RAM), Read-Only Memory (ROM), Non-volatile RAM (NVRAM), Flash Memory, hard disk storage, etc.) stores data (e.g., operating parameter data) and/or computer code (e.g., operating parameter filtering or processing algorithms, etc.)) for facilitating at least some of the various processes described herein. The memory 344 may include tangible, non-transient volatile memory, or non-volatile memory. The memory 344 may include a non-transitory processor readable medium having stored programming logic that, when executed by the processor 342, controls the operations of the nanocell computation system 340. In some arrangements, the memory 344 and the processor 342 form various processing circuits described with respect to the nanocell computation system 340.

The communication interface(s) 346 can include one or more satellite, WI-FI®, BLUETOOTH®, or cellular antenna. In some embodiments, the communication interface(s) 346 can be communicably coupled to an external device (e.g., an external processor) that includes one or more satellite, WI-FI, BLUETOOTH®, or cellular antenna, or a power source such as a battery or a solar panel. In some embodiments, the communication interface(s) 346 can be configured to receive a first operating parameter signal, for example, from the first operating parameter computation system 330) indicative of initial first operating parameters or estimated first operating parameters estimated by the first operating parameter computation system 330, as previously described herein. In some embodiments, the communication interface 346 may also be configured to receive a second operating parameter signal and optionally, a model operating parameter signal, from the simulation system S indicative of the second operating parameters of a modeled electrochemical cell(s), stack(s), or assembly(ies) estimated by the simulation system S, or other model operating parameters input into the simulation system S, respectively, as previously described herein. In some embodiments, the communication interface 346 may also be configured to communicate a nanocell generation signal to the simulation system S, which is configured to cause the simulation system S to divide the modeled electrochemical cell(s), stack(s), or assembly(ies) into a plurality of nanocells or otherwise map a plurality of nanocells onto the modeled electrochemical cell(s), stack(s), or assembly(ies), with each of the nanocells having predetermined dimensions being equal in dimension to each other.

In some embodiments, the communication interface 346 may also be configured to communicate a first operating parameter signal to the simulation system S, which is indicative of the initial or estimated first operating parameters. In some embodiments, the communication interface 346 may also be configured to communicate a simulation system interrupt signal to the simulation system S to interrupt or stop the simulation system after a predetermined time or after the simulation system S has performed a predetermined number of iteration cycles. In some embodiments, the communication interface 346 may also be configured to communicate a second operating parameter signal and optionally, a model operating parameter signal to the first operating parameter computation system 330, which are indicative of the second operating parameters of a modeled electrochemical cell(s), stack(s), or assembly(ies) estimated by the simulation system S, or other model operating parameters input into the simulation system S, respectively, as previously described herein.

In some embodiments, the nanocell computation system 340 may include various modules implemented in hardware or software configured to perform the operations of the nanocell computation system 340. For example, as shown in FIG. 9, the nanocell computation system 340 includes a nanocell generation module 344a, a first operating parameter module 344b, a simulation system interruption module 344c, a second operating parameter module 344d, and optionally, a model operating parameter module 344e. It should be appreciated that these modules are for illustrative purposes only and the nanocell computation system 340 may include any other module, circuitries, sub systems, etc. to facilitate the nanocell computation system 340 in performing the operations thereof.

In one configuration, the nanocell generation module 344a, the first operating parameter module 344b, the simulation system interruption module 344c, the second operating parameter module 344d, and the model operating parameter module 344e can be embodied as machine or computer-readable media (e.g., stored in the memory 344) that is executable by a processor, such as the processor 342. As described herein and amongst other uses, the machine-readable media (e.g., the memory 344) facilitates performance of certain operations the nanocell generation module 344a, the first operating parameter module 344b, the simulation system interruption module 344c, the second operating parameter module 344d, and the model operating parameter module 344e to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). Thus, the computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, wireless network, etc.)

In another configuration, the nanocell generation module 344a, the first operating parameter module 344b, the simulation system interruption module 344c, the second operating parameter module 344d, and the model operating parameter module 344e may include circuitry components including, but not limited to, processing circuitry, network interfaces, peripheral devices, input devices, output devices, sensors, etc.

In some embodiments, the nanocell generation module 344a, the first operating parameter module 344b, the simulation system interruption module 344c, the second operating parameter module 344d, and the model operating parameter module 344e may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit” In this regard, the nanocell generation module 344a, the first operating parameter module 344b, the simulation system interruption module 344c, the second operating parameter module 344d, and the model operating parameter module 344e may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on.

Thus, the nanocell generation module 344a, the first operating parameter module 344b, the simulation system interruption module 344c, the second operating parameter module 344d, and the model operating parameter module 344e may also include programmable hardware devices such as field programmable gate arrays, programmable array logic, programmable logic devices or the like. In this regard, the nanocell generation module 344a, the first operating parameter module 344b, the simulation system interruption module 344c, the second operating parameter module 344d, and the model operating parameter module 344e may include one or more memory devices for storing instructions that are executable by the processor(s) of nanocell generation module 344a, the first operating parameter module 344b, the simulation system interruption module 344c, the second operating parameter module 344d, and the model operating parameter module 344e. The one or more memory devices and processor(s) may have the same definition as provided below with respect to the memory 344 and the processor 342.

In the example shown, the nanocell computation system 340 includes the processor 342 and the memory 344. The processor 342 and the memory 344 may be structured or configured to execute or implement the instructions, commands, and/or control processes described herein with respect to the nanocell generation module 344a, the first operating parameter module 344b, the simulation system interruption module 344c, the second operating parameter module 344d, and the model operating parameter module 344e. Thus, the depicted configuration represents the aforementioned arrangement in which the nanocell generation module 344a, the first operating parameter module 344b, the simulation system interruption module 344c, the second operating parameter module 344d, and the model operating parameter module 344e are embodied as machine or computer-readable media. However, as mentioned above, this illustration is not meant to be limiting as the present disclosure contemplates other embodiments such as the aforementioned embodiment in which the nanocell generation module 344a, the first operating parameter module 344b, the simulation system interruption module 344c, the second operating parameter module 344d, and the model operating parameter module 344e, or at least one circuit thereof, are configured as a hardware unit. All such combinations and variations are intended to fall within the scope of the present disclosure. In some embodiments, the one or more processors may be shared by multiple circuits (e.g., the nanocell generation module 344a, the first operating parameter module 344b, the simulation system interruption module 344c, the second operating parameter module 344d, and the model operating parameter module 344e) may include or otherwise share the same processor which, in some example embodiments, may execute instructions stored, or otherwise accessed, via different areas of memory 344.

The nanocell generation module 344a may be configured to receive a nanocell dimension signal (e.g., input into the nanocell computation system 340 by a user through the communication interface 346) that is indicative of the dimension that each nanocell is desired to be generated at, as previously described herein. The nanocell generation module 344a may also be configured to generate a nanocell generation signal that is configured to cause the simulation system S to divide the modeled electrochemical cell into the plurality of nanocells, or map the plurality of nanocells onto the modeled electrochemical cell, as previously described herein.

The first operating parameter module 344b may be configured to receive a first operating parameter signal, for example, from the first operating parameter computation system 330, which is indicative of a first operating parameter (e.g., impedance or any other first operating parameter described herein) of each of the plurality of nanocells mapped onto the modeled electrochemical cell or otherwise, which the modeled electrochemical cell is divided into. The first operating parameter signal may be provided by a user, or estimated by the first operating parameter computation system 330, as previously described herein. The first operating parameter module 344b may also be configured to generate a first operating parameter signal that is communicated to the simulation system S and is configured to cause the simulation system S to determine second operating parameters of each of the plurality of nanocells, as previously described herein.

The simulation system interruption module 344c may be configured to generate a simulation system interrupt signal configured to interrupt the simulation system S after the simulation system S has performed a predetermined number of its iterative solving cycles or steps, or after a predetermined time, as previously described herein.

The second operating parameter module 344d may be configured to receive a second operating parameter signal from the simulation system S that is indicative of second operating parameters (e.g., temperature, heat generated, current density, or any other second operating parameter described herein) estimated for each of the plurality of nanocells that the modeled electrochemical cell is divided into. The second operating parameter module 344d may also configured to generate a second operating parameter signal that may be communicated to the first operating parameter computation system 330 to cause the first operating parameter computation system 330 to determine a new set of first operating parameters for each of the plurality of nanocells, as previously described herein. The first operating parameter computation system 330 may then generate a new first operating parameter signal that is communicated to the first operating parameter module 344b, which is indicative of new first operating parameters for each of the plurality of nanocells for communicating to the simulation system S.

In some embodiments, the model operating parameter module 344e may be configured to receive a model operating parameter signal from the simulation system S, which is indicative of model operating parameters corresponding to the modeled electrochemical cell and different from the second operating parameter (e.g., pressure, fluid flow, ambient temperature, charge rate, SOC, or any other model operating parameter as previously described herein). The model operating parameter module 344e may also be configured to generate a model operating parameter signal indicative of the model operating parameters that may be communicated to the first operating parameter computation system 330 that may be used by the first operating parameter computation system 330 to determine the first operating parameters for each of the plurality of nanocells, as previously described herein.

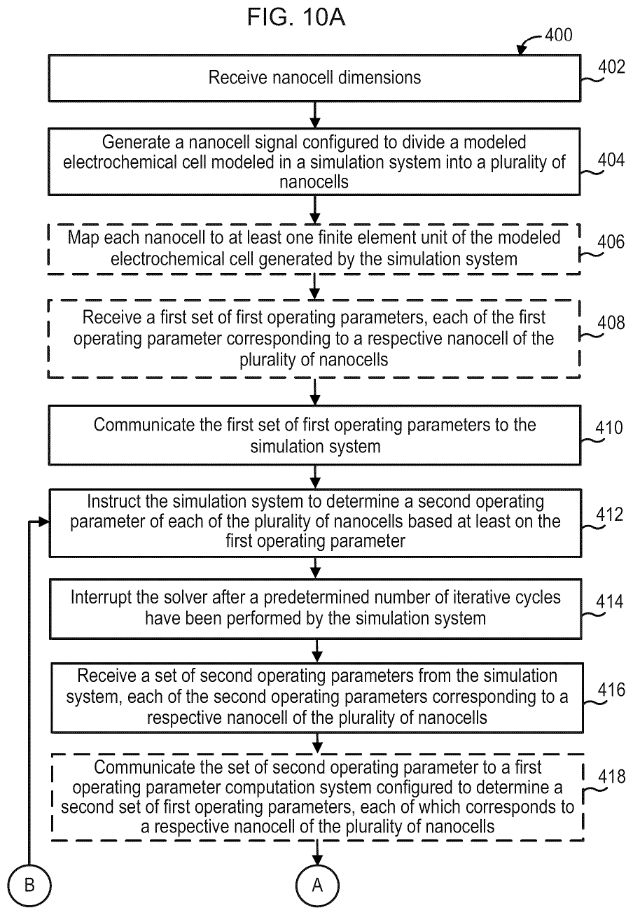

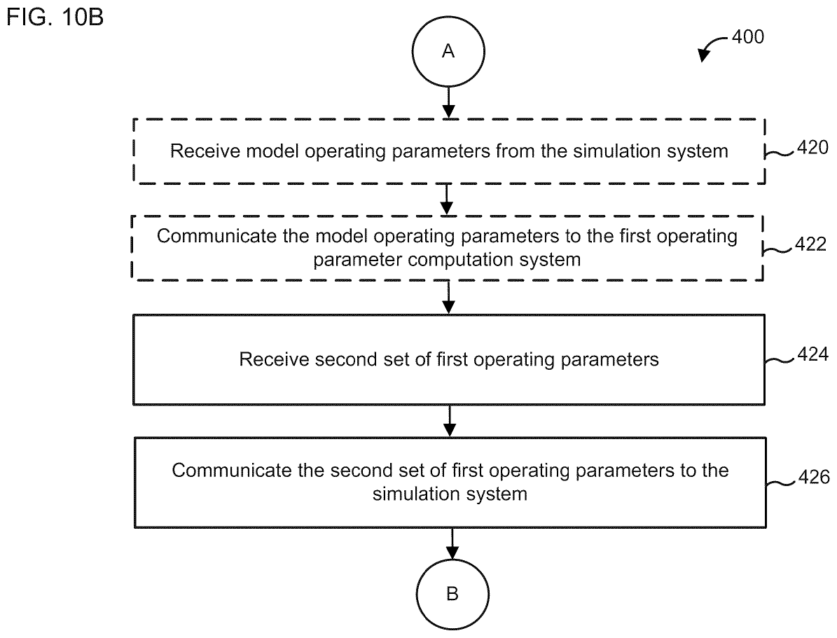

FIG. 10A-1013 show a schematic flow chart of a method 400 for generating nanocells having a predetermined dimension and dividing a modeled electrochemical cell(s), stack(s), assembly(ies) modeled in a simulation system S into a plurality of nanocells whose properties can be independently varied, according to an embodiment. While described with respect to the nanocell computation system 340, the first operating parameter computation system 330, and the simulation system S, the operations of the method 400 can be performed with any computation system, computing device, or controller capable of performing the operations of the method 400. All such implementations are envisioned and should be considered to be included within the scope of the present application.

The method 400 may include receiving a signal indicative of nanocell dimensions, by the nanocell computation system 340, at 402. For example, a user may enter or input the desired dimensions for each of the nanocell into the nanocell computation system 340, as previously described herein. At 404, the nanocell computation system 340 generates a nanocell signal configured to divide a modeled electrochemical cell modeled in the simulation system S into a plurality of nanocells, as previously descried herein. In some embodiments, the nanocell computation system 340 may also map each nanocell of the plurality of nanocells to at least one finite element unit that the simulation system S meshes the modeled electrochemical cell into, at 406, as previously described herein.

In some embodiments, the nanocell computation system 340 may receive a first set of first operating parameters from the first operating parameter computation system 330 or input by a user, at 408. Each of the first operating parameter may correspond to a respective nanocell of the plurality of nanocells, as previously described herein. At 410, the nanocell computation system 340 communicates the first set of first operating parameters to the simulation system S, as previously described herein. The simulation system S is configured to perform iterative solving cycles on each of the plurality of nanocells dividing the modeled electrochemical cell into the plurality of nanocells, as previously described herein.

At 410, the nanocell computation system 340 communicates the first set of first operating parameters to the simulation system S, as previously described herein. At 412, the nanocell computation system 340 instructs the simulation system S to determine a second operating parameter of each of the plurality of nanocells based at least on the corresponding first operating parameter (e.g., also based on model operating parameters), as previously described herein.

At 414, the nanocell computation system 340 interrupts the simulation system S after a predetermined number of iterative solving cycles have been performed by the simulation system S, or after a predetermined time, as previously described herein. At 416, the nanocell computation system 340 receives a set of second operators from the simulation system S. Each of the second operating parameter corresponds to a respective one of the plurality of nanocells, as previously described herein. In some embodiments, the nanocell computation system 340 may communicate the set of second operating parameters to the first operating parameter computation system 330, at 418. The first operating parameter computation system 330 may be configured to determine a second set of first operating parameters, each of which corresponds to a respective nanocell of the plurality of nanocells, based at least on the set of second operating parameters, as previously described herein.

In some embodiments, the nanocell computation system 340 may also receive model operating parameters from the simulation system S, at 420, as previously described herein. In some embodiments, the nanocell computation system 340 may also communicate the model operating parameters to the first operating parameter computation system, at 422. In such embodiments, the first operating parameter computation system 330 may be configured to determine the second set of first operating parameters based also on the model operating parameters, as previously described herein.

At 424, the nanocell computation system 340 receives the second set of first operating parameters from the first operating parameter computation system 330, as previously described herein. In some embodiments, instead of communicating the set of second operating parameters and optionally, the model operating parameters to the first operating parameter computation system 330, the nanocell computation system 340 may itself be configured to estimate the second set of first operating parameters based on the set of second operating parameters, and optionally, the model operating parameters. At 426, the nanocell computation system 340 communicates the second set of first operating parameters to the simulation system S, as previously described herein, and the method 400 returns to operation 412.

It should be understood that no claim element herein is to be construed under the provisions of 35 U.S.C. § 112(f) unless the element is expressly recited using the phrase “means for.”

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B), in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one ofA and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A computation system, comprising;
a processor;
a memory operatively coupled to the processor, the memory storing executable instructions that, when executed by the processor, facilitate performance of operations, the operations comprising:
receiving a dimension signal indicative of a dimension of a nanocell;
communicating a nanocell signal to a simulation system, the nanocell signal configured to divide a modeled electrochemical cell modeled in the simulation system into a plurality of nanocells based on the received dimension of the nanocell;
communicating a first set of first operating parameters to the simulation system, each of the first operating parameter in the first set of first operating parameters corresponding to a respective nanocell of the plurality of nanocells;
communicating a solve signal to the simulation system, the solve signal configured to cause the simulation system to determine a second operating parameter of each of the plurality of nanocells based at least on a corresponding first operating parameter;
communicating an interrupt signal to the simulation system, the interrupt signal configured to interrupt the simulation system after a predetermined number of iterative solving cycles performed by the simulation system on each of the plurality of nanocells;
receiving a set of second operating parameters from the simulation system, each of the second operating parameter of the set of second operating parameters corresponding to a respective nanocell of the plurality of nanocells;
receiving a second set of first operating parameters determined based at least on the set of second operating parameters, each of the first operating parameter in the second set of first operating parameters corresponding to a respective nanocell of the plurality of nanocells; and
communicating the second set of first operating parameters to the simulation system for determining an updated second operating parameter of each nanocell of the plurality of nanocells.

2. The computation system of claim 1, wherein each nanocell has at least one of a square, rectangular, triangular, polygonal, or asymmetric shape.

3. The computation system of claim 2, wherein each of the plurality of nanocells has a cube shape.

4. The computation system of claim 3, wherein the dimension of the nanocell is in range of about 1 cubic micron to about 125 cubic centimeter.

5. The computation system of claim 1, wherein each of the first operating parameter included in the first set of first operating parameters or the second set of first operating parameters includes an impedance.

6. The computation system of claim 5, wherein each of the second operating parameter included in the set of second operating parameters includes at least one of a temperature, a heat, or a current density.

7. The computation system of claim 1, wherein the operations further comprise:
receiving the first set of first operating parameters from a first operating parameter computation system, the first set of first operating parameters estimated by the first operating parameter system based on test operating parameters of a set of test electrochemical cells received by the first operating parameter computation system.

8. The computation system of claim 7, wherein the test operating parameters include at least one of a dimension, a temperature, a state of charge, a pressure, a chemical composition, a porosity, an ion speed, a degradation level, a cell end of life, a joule heating, a reactive heating, or a fluid flow around the set of test electrochemical cells.

9. The computation system of claim 7, wherein the operations further comprise:
communicating the set of second operating parameters to the first operating parameter computation system; and
receiving the second set of first operating parameters from the first operating parameter computation system, the second set of first operating parameters estimated by the first operating parameter computation system based on at least the set of second operating parameters.

10. The computation system of claim 9, wherein the operations further comprise:
communicating model operating parameters received from the simulation system to the first operating parameter computation system, the model operating parameters corresponding to the modeled electrochemical cell and thereby, to each of the plurality of nanocells,
wherein the second set of first operating parameters are estimated by the first operating parameter computation system based also on the model operating parameters.

11. The computation system of claim 10, wherein the model operating parameter includes at least one of a state of charge, a pressure, ambient temperature, a chemical composition, a porosity, an ion speed, a degradation level, a cell end of life, a joule heating, a reactive heating, or a fluid flow around the modeled electrochemical cell and thereby, each of the plurality of nanocells.

12. The computation system of claim 1, wherein:
the simulation system is configured to divide the modeled electrochemical cell into a plurality of finite element units; and
the operations further comprise mapping the plurality of nanocells to the plurality of finite element units such that one nanocell, a plurality of nanocells, or a fraction of a nanocell are mapped to each finite element unit.

13. A computation system, comprising:
a processor;
a memory operatively coupled to processor, the memory storing executable instructions that, when executed by the processor, facilitate performance of operations, the operations comprising:
receiving a signal indicative of a plurality of test impedance values obtained from a set of test electrochemical cells over a range of test operating parameters;
determining an impedance function based on the test impedance values and the range of test operating parameters, the impedance function defined to estimate an operational impedance value of an electrochemical cell at a cell operating parameter;
receiving a signal indicative of the cell operating parameter of the electrochemical cell;
estimating an impedance value of the electrochemical cell at the cell operating parameter based on the impedance function; and
generating an impedance signal indicative of the estimated impedance value.

14. The computation system of claim 13, wherein the operations further comprise generating an impedance function signal indicative of the impedance function.

15. The computation system of claim 13, wherein the range of test operating parameters include at least one of a dimension, a temperature, a state of charge (“SOC”), a number of charge and discharge cycles, a pressure, a chemical composition, a porosity, an ion speed, a degradation level, a cell end of life, a joule heating, or a reactive heating of the electrochemical cell.

16. The computation system of claim 15, wherein the test operating parameters include a range of test temperature values and a range of test SOC values.

17. The computation system of claim 16, wherein the impedance function comprises a cubic order polynomial function.

18. The computation system of claim 17, wherein the cubic order polynomial function comprises the following equation:
$${R}_{T} = {{P}_{o} ( 1 - u )}^{3} + 3 {{P}_{1} ( 1 - u )}^{2} + {P}_{2} {u}^{2} ( 1 - u ) + {P}_{3} {u}^{3} ,$$
where:
R_{T} is the estimated impedance value at a specific cell operating temperature,
P₀, P₁, P₂, and P₃ are test impedance values at various test operating temperatures obtained from the set of test electrochemical cells at a SOC value within the range of SOC values, and
u is a normalization parameter for temperature.

19. The computation system of claim 18, wherein:
$$u = \frac{T + 20}{50} ,$$
where T is the cell operating temperature at which the electrochemical cell is operating.

20. The computation system of claim 16, wherein the impedance function comprises a fourth order polynomial function.

21. The computation system of claim 20, wherein the fourth order polynomial function comprises the following equation:
$${R}_{T} = a {T}^{4} + b {T}^{3} + c {T}^{2} + d T + e ,$$
where:
R_{T} is the impedance value at a cell operating temperature at which the electrochemical cell is operating,
a, b, c, d, and e are constants obtained from the test impedance values, and
T is the cell operating temperature.

22. The computation system of claim 20, wherein the impedance function comprises the following equation:
$$R = {R}_{T} ( {C}_{F} + {S}_{F} )$$
where:
$${R}_{T} = a {T}^{4} + b {T}^{3} + c {T}^{2} + d T + e$$
where R_{T} is the impedance value at a cell operating temperature at which the electrochemical cell is operating, a, b, c, d, and e are constants obtained from the test impedance values, and T is the cell operating temperature;
C_{F} is a cycle factor; and
S_{F} is a SOC factor at the specific cell operating parameter.

23. The computation system of claim 22, wherein S_{F} comprises the following equation:
$${S}_{F} = \frac{{R}_{S}}{2.36}$$
where:
$${R}_{S} = x {S}^{2} - y S + z$$
where x, y, and z are constants obtained from the test impedance values, and 0≤S=SOC≤1.
